(19) United States
(12) Patent Application Publication
(10) Pub. No.: US 2025/0133333 A1
(43) Pub. Date: Apr. 24, 2025

(54) WINDOW CONTAINING SPEAKER DESIGN

(71) Applicant: Logitech Europe S.A., Lausanne (CH)

(72) Inventors: Charles Edmond DUGGER, Camas, WA (US); Calhoun Ernst ZABEL, Vancouver, WA (US); Daniel Ryan MARQUEZ, Vancouver, WA (US)

(21) Appl. No.: 18/923,633

(22) Filed: Oct. 22, 2024

Related U.S. Application Data
(60) Provisional application No. 63/545,530, filed on Oct. 24, 2023.

(51) Int. Cl. H04R 1/28; H04R 1/02; H04R 1/24; H04R 1/26; H04R 1/34

(52) U.S. Cl. CPC H04R 1/2826; H04R 1/025; H04R 1/24; H04R 1/26; H04R 1/345

(57) ABSTRACT

A speaker assembly includes a speaker body comprising an outer surface that comprises a first slit exit port and a second slit exit port. The speaker further includes a slit that extends within the speaker body between the first slit exit port and the second slit exit port. The slit includes a slit volume that is partially defined by inner surfaces of the slit. A first driver having a front end that forms part of the inner surface of the slit and defines a first portion of the slit volume.

### CROSS-REFERENCE TO RELATED APPLICATIONS

This application claims the benefit of U.S. Provisional Patent Application Ser. No. 63/545,530 filed Oct. 24, 2023 which is hereby incorporated by reference.

### BACKGROUND

### Field

Embodiments of the present disclosure generally relate to a speaker assembly and a speaker system.

### Description of the Related Art

The popularity and reliance on electronic devices has increased dramatically in the past decade. As the number of electronic devices and the reliance on these electronic devices has increased, there has been an increased desire for these devices to generate soundwaves that are true to the original audio source's sound quality no matter where a user is positioned relative to the electronic device. Sound quality is generally used to gauge or measure the accuracy with which a device reproduces an original sound. Conventional electronic devices, such as portable speakers or table top mounted audio generating devices, typically include a speaker that is configured to deliver sound waves that vary within an audible frequency range and are positioned and oriented to deliver the sound waves in a preferred direction based on the way the electronic device is configured and/or designed to be positioned within the local environment. The directional nature of the delivered sound waves provided from typical conventional electronic devices is especially noticeable at the higher end of the audible frequency range, which can lead to an undesirable experience for a user as they move throughout and/or reposition themselves within the local environment relative to the sound producing electronic device.

Moreover, in the case of portable electronic devices, smaller and lighter devices are desirable due to the more portable nature of these types of electronic devices. However, reducing the size of the device can have a negative effect on the audio performance of the electronic device due to the reduced internal acoustic volume formed within an internal region in which a speaker (audio driver) is positioned. In particular, bass performance is generally compromised by using a smaller sized internal acoustic volume. The device's enclosure immediately behind the speaker has a significant impact on the audio performance. It is thus often a balance between a desire to maximize the acoustic volume and the desire to make the electronic device easily portable and easily transportable, while also providing a high quality sound output.

Accordingly, there is a need for an improved speaker assembly that solves the problems described above.

### SUMMARY

According to one or more embodiments, a speaker assembly includes a speaker body comprising an outer surface that comprises a first slit exit port and a second slit exit port, a slit that extends within the speaker body between the first slit exit port and the second slit exit port, and includes a slit volume that is partially defined by inner surfaces of the slit, and a first driver having a front end that forms part of the inner surface of the slit and defines a first portion of the slit volume.

According to one or more embodiments, a speaker assembly includes a speaker body comprising an outer surface that comprises a first slit exit port and a second slit exit port, a slit that extends within the speaker body between the first slit exit port and the second slit exit port, wherein the first slit exit port and the second slit exit port have a pill shape or a rectangular shape, and the slit includes a slit volume that is partially defined by inner surfaces of the slit, and a first driver having a front end that forms part of the inner surface of the slit and defines a first portion of the slit volume.

According to one or more embodiments, a speaker assembly includes a speaker body comprising an outer surface that comprises a first slit exit port, a second slit exit port, a third slit exit port and a fourth slit exit port, a first slit that extends within the speaker body between the first slit exit port and the second slit exit port and the first slit comprises a first slit volume that is partially defined by inner surfaces of the first slit, a second slit that extends within the speaker body between the third slit exit port and the fourth slit exit port, wherein the second slit is positioned a first distance from the first slit, the second slit comprises a second slit volume that is partially defined by inner surfaces of the second slit, a first pair of drivers disposed within the first slit, each of the first pair of drivers having a front end that forms part of the inner surface of the first slit and defines a portion of the first slit volume, and a second pair of drivers disposed within the second slit, each of the second pair of drivers having a front end that forms part of the inner surface of the second slit and defines a portion of the second slit volume.

### BRIEF DESCRIPTION OF THE DRAWINGS

The file of this patent contains at least one drawing executed in color. Copies of this patent with color drawing(s) will be provided by the Patent and Trademark Office upon request and payment of the necessary fee.

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1A illustrates a top view of a conventional audio speaker design disposed within a local environment.

FIG. 1B illustrates a color heat map graph illustrating a dispersion of the audible output of a first type of the audio speaker shown in FIG. 1A as a function of angle.

FIG. 1C illustrates a top view of an alternate two driver version of a conventional audio speaker design disposed within a local environment.

FIG. 1D illustrates a color heat map graph illustrating a dispersion of an audible output of the alternate two driver version of the audio speaker design that is configured similarly to the audio speaker of FIG. 1C as a function of angle.

FIG. 2 illustrates a perspective view of a speaker assembly, according to certain embodiments.

FIG. 3 is a graph illustrating an example of a relative magnitude of a sound pressure level (SPL) of an audible output of an audio speaker assembly as a function of frequency.

FIG. 4A illustrates a schematic, cross-sectional top view of the speaker assembly illustrated in FIG. 2 sectioned along an X-Y-plane. according to certain embodiments.

FIG. 4B illustrates a tilted isometric schematic, cross-sectional perspective view of the speaker assembly of FIG. 4A, according to certain embodiments.

FIG. 4C illustrates a schematic, cross-sectional side view of the speaker assembly illustrated in FIG. 2 sectioned along an X-Z-plane, according to certain embodiments.

FIG. 5A illustrates a front side view of a speaker assembly, according to certain embodiments.

FIG. 5B illustrates a simplified, cross-sectional top view of the speaker assembly sectioned along a section line 5B-5B shown in FIG. 5A, according to certain embodiments.

FIG. 5C illustrates a simplified, cross-sectional top view of an alternate type of speaker assembly configuration formed using the section line 5B-5B shown in FIG. 5A, according to certain embodiments.

FIG. 6A illustrates a front side view of a speaker assembly, according to certain embodiments.

FIG. 6B illustrates a simplified, cross-sectional side view of the speaker assembly sectioned along a section line 6B-6B shown in FIG. 6A, according to certain embodiments.

FIG. 7A illustrates a front side view of a speaker assembly in a first configuration, according to certain embodiments.

FIG. 7B illustrates a front side view of a speaker assembly in a second configuration, according to certain embodiments.

FIG. 8A illustrates a color heat map graph illustrating the dispersion of an audible output of a speaker assembly, according to certain embodiments.

FIG. 8B illustrates a color heat map graph illustrating the dispersion of an audible output of a speaker assembly, according to certain embodiments.

FIG. 9A illustrates a color heat map graph illustrating the dispersion of an audible output of a speaker assembly according to certain embodiments.

FIG. 9B illustrates a color heat map graph illustrating the dispersion of an audible output of a speaker assembly according to certain embodiments.

FIG. 10A illustrates a color heat map graph illustrating the dispersion of an audible output of a speaker assembly according to certain embodiments.

FIG. 10B illustrates a color heat map graph illustrating the dispersion of an audible output of a speaker assembly according to certain embodiments.

FIG. 11A illustrates a color heat map graph illustrating the dispersion of an audible output of a speaker assembly according to certain embodiments.

FIG. 11B illustrates a color heat map graph illustrating the dispersion of an audible output of a speaker assembly according to certain embodiments.

FIG. 11C illustrates a color heat map graph illustrating the dispersion of an audible output of a speaker assembly according to certain embodiments.

FIG. 12A illustrates a cross-sectional view of a first configuration of the speaker assembly illustrated in FIG. 2 formed by sectioning along the Y-Z-plane in FIG. 2, according to certain embodiments.

FIG. 12B illustrates a cross-sectional view of a second configuration of the speaker assembly illustrated in FIG. 2 formed by sectioning along the Y-Z-plane in FIG. 2, according to certain embodiments.

FIG. 12C illustrates a cross-sectional view of a third configuration of the speaker assembly illustrated in FIG. 2 formed by sectioning along the Y-Z-plane in FIG. 2, according to certain embodiments.

FIG. 13A illustrates a color heat map graph illustrating the dispersion of an audible output of a speaker assembly according to certain embodiments.

FIG. 13B illustrates a color heat map graph illustrating the dispersion of an audible output of a speaker assembly according to certain embodiments.

FIG. 13C illustrates a color heat map graph illustrating the dispersion of an audible output of a speaker assembly according to certain embodiments.

FIG. 14A illustrates a front side view of a speaker assembly, according to certain embodiments.

FIG. 14B illustrates a simplified, cross-sectional side view of the speaker assembly sectioned along a section line 13B-13B shown in FIG. 13A, according to certain embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments herein are generally directed to a speaker assembly that is configured to support one or more audio drivers, which is also referred to herein as loudspeakers, speakers or simply drivers, that generate audible sound waves based on electrical signals provided from an audible signal generating electronic device during use. More specifically, embodiments of the disclosure include a speaker assembly that includes a plurality of drivers that are positioned to generate sound waves within a window region, or also referred to herein as a slot or slit shaped region, which is formed within a speaker body of a speaker assembly. In some embodiments, as will be discussed further below, the speaker assembly includes one or more slits that each extend between opposing sides of an exterior surface of the speaker assembly and includes one or more slit design characteristics that have been adjusted or tuned to improve one or more sound delivery characteristics, such as frequency sensitivity and sound dispersion of the driver generated sound waves within a desired frequency range. As is discussed further below, the one or more slit design characteristics of a formed slit can include a slit width, a slit height, a slit length, one or more edge radii, a desired driver size and orientation within a slit, and other useful features.

In one example of the speaker assembly, the driver is a voice coil containing device, which includes a magnet, diaphragm (cone), voice coil (wire coil), and suspension mechanism that are configured to generate audible sound waves based on a received electrical signal. Within a driver, the voice coil, which is a coil of wire, is used to generate a varying magnetic field that causes the movement of the diaphragm relative to a stationary magnet to generate sound waves. The frequency of the sound waves produced by the driver is dictated by the frequency of the electrical signal administered to the voice coil. Louder signals result in greater diaphragm (cone) displacement, yielding louder sound waves. The type of sound waves a speaker can produce is determined in part by the diaphragm's size and shape, with small diaphragms being better suited for the generation of high-frequency sound waves and large diaphragms excelling in low-frequency sound wave reproduction. The diaphragm, which is an externally visible part of the driver, is typically fashioned from lightweight and rigid materials, such as paper, plastic, or metal, while the voice coil is attached to the rear of the diaphragm, and the magnet is centrally located within the driver.

Various types of drivers can be employed to reproduce distinct frequency ranges, such as woofers for low frequencies, midrange drivers for mid-range frequencies, and tweeters for high frequencies. In some cases, full-range drivers, which can generate soundwaves across a wide range of frequencies, are used in some applications. Speaker assemblies can also incorporate multiple drivers to produce a wider frequency range, for example, a three-way speaker system. The positioning of drivers facing away from each other, such as in cylindrical speaker systems, aims to enhance sound quality by creating an improved stereo image, and by minimizing unwanted sound interference as the acoustic waves produced by the drivers interact less with each other. However, in a cylindrical shaped speaker, large flat cuts are needed on the exterior surfaces to allow proper mounting of the drivers causing the acoustic volume to suffer, resulting in less efficient use of the drivers.

Further, a passive radiator, a diaphragm that reacts to fluctuations in air pressure, may be incorporated into a speaker assembly. Unlike traditional drivers, passive radiators lack a voice coil or magnet and operate via the air pressure generated by the active driver(s) within the speaker enclosure. Passive radiators are often employed in compact speaker designs to extend bass response and enhance overall sound quality. They offer benefits such as extended bass response, improved efficiency, reduced distortion at low frequencies, and more compact enclosure design. However, they also entail higher costs, and necessitate careful design(s) and tuning.

As discussed above, the acoustic volume of a speaker affects the performance of the speaker. Acoustic volume denotes the net volume of air within the speaker enclosure to which the backside of a driver's diaphragm is coupled, measured in cubic volume units such as cubic liters or cubic feet. The acoustic volume significantly impacts a driver's performance in various aspects. A larger acoustic volume leads to improved performance and efficiency at bass frequencies. However, it also comes with the drawbacks of increased size, weight, and cost. Therefore, it is desirable to maximize the acoustic volume while trying to maintain a desired structural size of the electronic device.

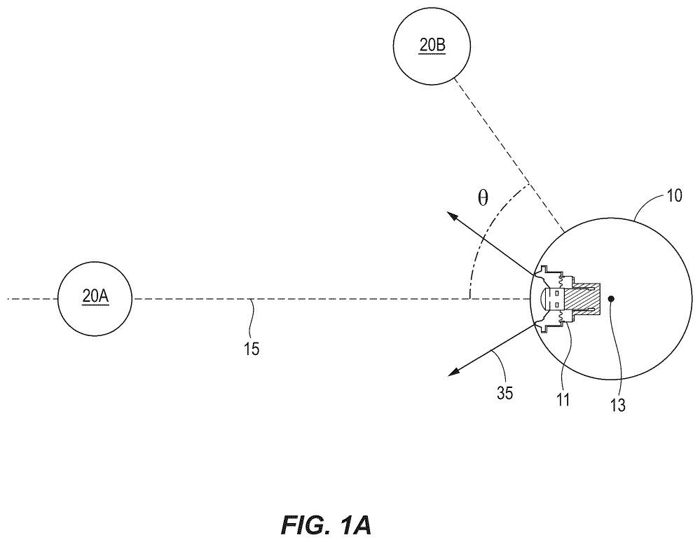

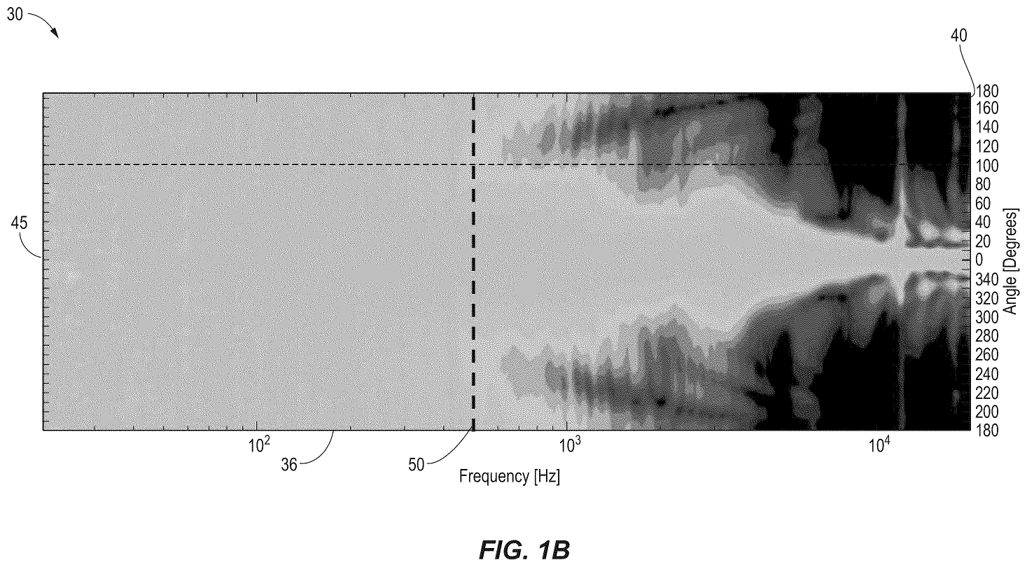

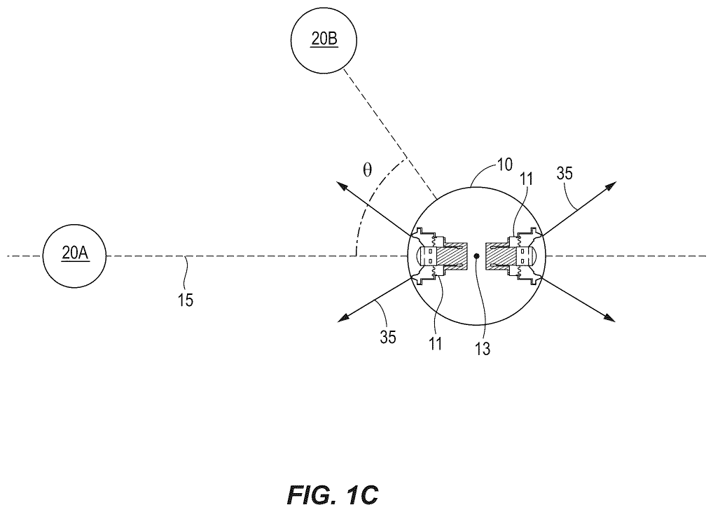

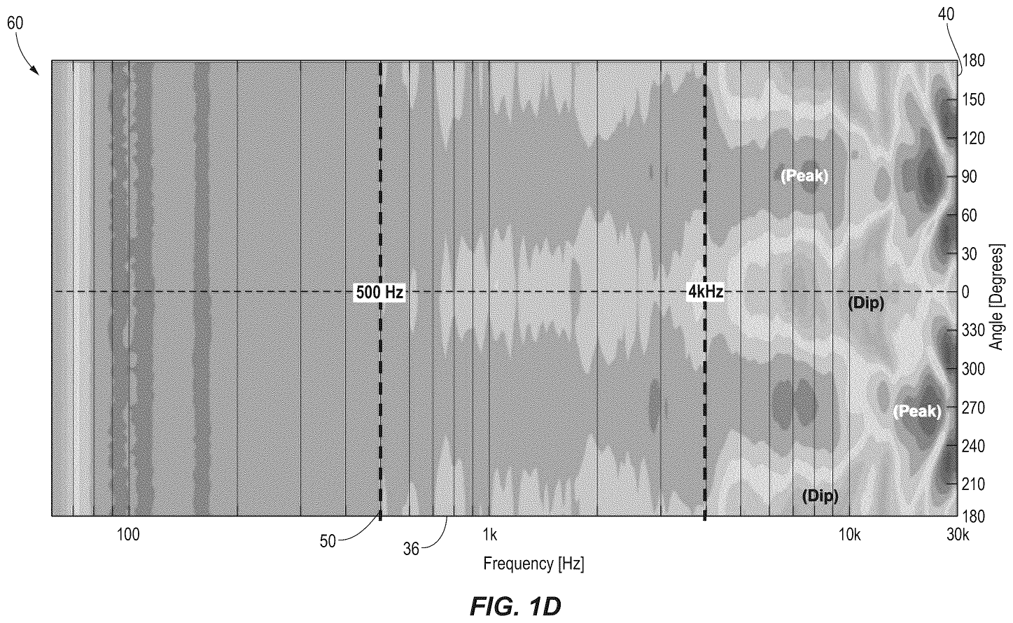

FIG. 1A illustrates a top view of an audio speaker assembly 10. Typically, audio speakers, such as audio speaker assembly 10 include a driver 11 that is positioned in an opening formed in the speaker body of the audio speaker assembly 10. However, the sound output from a driver is only omnidirectional until the sound output by the audio driver reaches a certain frequency. In general, the certain frequency is in a low frequency range such as less than 500 Hz, such as in a range generally provided by subwoofers which can include frequencies in a range from about 50 Hz to about 120 Hz. Once the sound output by the driver 11 of audio speaker assembly 10 exceeds the certain low frequency, the sound output by the driver 11 becomes directional. For example, once the sound output by the driver 11 reaches the certain frequency, the quality of sound heard by a user depends on an angle formed between the user and a direction (e.g., speaker axis 15) that extends through the center of the driver 11 of the audio speaker assembly 10. The audible output 35 of the driver 11 is directional with respect to a speaker axis 15 located through the center of the driver 11. Stated differently, at the higher frequencies, such as frequencies greater than 2,000 Hz, produced by the driver 11 the farther a listener is off-axis from the speaker axis 15, the more likely the output of the driver 11 of the audio speaker assembly will include amplitude distortion or the detected SPL will vary as a function of angular direction.

For example, referring to FIG. 1A, a first listener 20A is located on the speaker axis 15. Stated differently, an angle between the first listener 20A and the driver 11 of the audio speaker assembly 10 is zero degrees (0°). A second listener 20B is located off of the speaker axis 15 at an angle θ as measured with respect to the speaker axis 15. As noted above, the greater the angle θ between the speaker axis and a user, the greater the amplitude distortion of the audible output 35 received by a user at frequencies greater than a frequency within the low frequency range. Once the frequency of the soundwaves within an audible output 35 includes frequencies outside of the low frequency range, the audible output 35 at these higher frequencies will appear to be amplitude distorted and/or the sound levels (SPL) experienced by the second listener 20B can vary greatly as the second listener 20B moves small angular distances from their off-axis position, which can lead to annoying variations in the perceived audible sounds received by second listener 20B.

FIG. 1B illustrates a color heat map graph 30 illustrating the magnitude of the audible output 35 (i.e., SPL level in dB) of the driver 11 of audio speaker assembly 10 of FIG. 1A as a function of angle (i.e., right vertical axis) and function of frequency (i.e., horizontal axis). Graph 30 illustrates a change of the SPL of the audible output 35 of the audio speaker assembly 10. The graph 30 includes an axis 36 that represents the frequency of the audible output 35 of the audio speaker assembly 10. An axis 40 of the graph 30 illustrates the angle θ between a user and the speaker axis 15 of the audio speaker assembly 10. In this example, as illustrated in graph 30, which is related to an output of a 4 inch woofer, the variation in the magnitude of the SPL across a 360° path that traverses from the zero degree angle (0°), which is aligned with the speaker axis 15 and front of the driver, around a central axis 13 (i.e., aligned with the Z-axis) of the audio speaker assembly 10 and back to the zero degree angle (0°). As shown in FIG. 1B, the magnitude of the SPL varies from a black color (e.g., ˜40 dB), to a blue color (e.g., ˜48-52 dB), to a green color (e.g., ˜68-72 dB), to an orange color (e.g., ˜82-84 dB), to a red color (e.g., ˜92-94 dB), and finally to a dark red color (e.g., ˜98-100 dB). Also, as shown in FIG. 1B, once the speaker reaches the edge of the low frequency range (i.e. vertical line 50 positioned at about 500 Hz), the audible output 35 of the audio speaker assembly 10 becomes more directional, and thus the 360° dispersion performance of the audio speaker assembly 10 deteriorates as the frequency of the audible output 35 increases along the horizontal axis. Therefore, in one example, the variation in the SPL heard by a first listener 20A as they reposition themselves within an angular range of ±5 degrees of the zero angle position (0°) will be small compared to a second user 20B positioned at an angle of 100 degrees and repositions themselves within the angular range of 95-105 degrees, especially for sounds that are provided at frequencies in higher frequency ranges (e.g., frequencies 2,000-20,000 Hz).

FIG. 1C illustrates a top view of an alternate conventional audio speaker design, which, for ease of discussion purposes, is also referred to herein a two driver version of the audio speaker assembly 10. In this example, the output of the alternate conventional audio speaker is provided by one left facing 40 mm driver and one right facing 40 mm driver, which are aligned in opposing outward facing directions along the speaker axis 15. Similar to the audio speaker assembly 10 design illustrated in FIG. 1A, the drivers 11 are positioned in two oppositely facing openings formed in the speaker body of the two driver version of the audio speaker assembly 10. The audible output 35 of the drivers 11 illustrated in FIG. 1C is directional with respect to a speaker axis 15 located through the center of the drivers 11.

FIG. 1D illustrates a color heat map graph 60 illustrating the magnitude of an audible output 35 (i.e., SPL level in dB) generated by the two driver version of the audio speaker assembly 10 that is similarly configured as FIG. 1C as a function of angle and function of frequency. The graph 60 illustrates a change of the sound intensity in dB (SPL) of an audible output 35 of the alternately configured two driver version of the audio speaker assembly 10. In this example, the output of the two driver version of the audio speaker assembly 10 is provided by one left facing 40 mm driver and one right facing 40 mm driver, which are aligned in opposing outward facing directions along the speaker axis 15 and aligned in the graph 60 at a 90° angle and a 270° angle, respectively. As shown in FIG. 1D, the magnitude of the SPL sequentially varies from a light blue color (e.g., ˜48-52 dB), to a green color (e.g., ˜68-72 dB), to an orange color (e.g., ˜82-84 dB), to a red color (e.g., ˜92-94 dB), and finally to a dark red color (e.g., ˜98-100 dB). Also, as shown in FIG. 1D, as soundwaves are increased in frequency and the speaker reaches the edge of the low frequency range (e.g., about 500 Hz), the audible output 35 of the audio speaker assembly 10 becomes more directional, and thus the dispersion uniformity performance of the two driver version of the audio speaker assembly 10 worsens, as observed by the multiple peaks and valleys in SPL at higher frequencies as one traverses around the central axis 13 of the audio speaker assembly 10. The dispersion uniformity performance worsens even further as the frequency of the soundwaves in the audible output 35 increases above 4,000 Hz. Therefore, in one example, the sound quality or variation in the SPL heard by either the first listener 20A or the second listener 20B will vary greatly as they reposition themselves within angular ranges of ±10 degrees in higher soundwave frequencies, for example, especially for soundwaves that are provided at frequencies in the higher frequency ranges (e.g., frequencies 4,500-20,000 Hz).

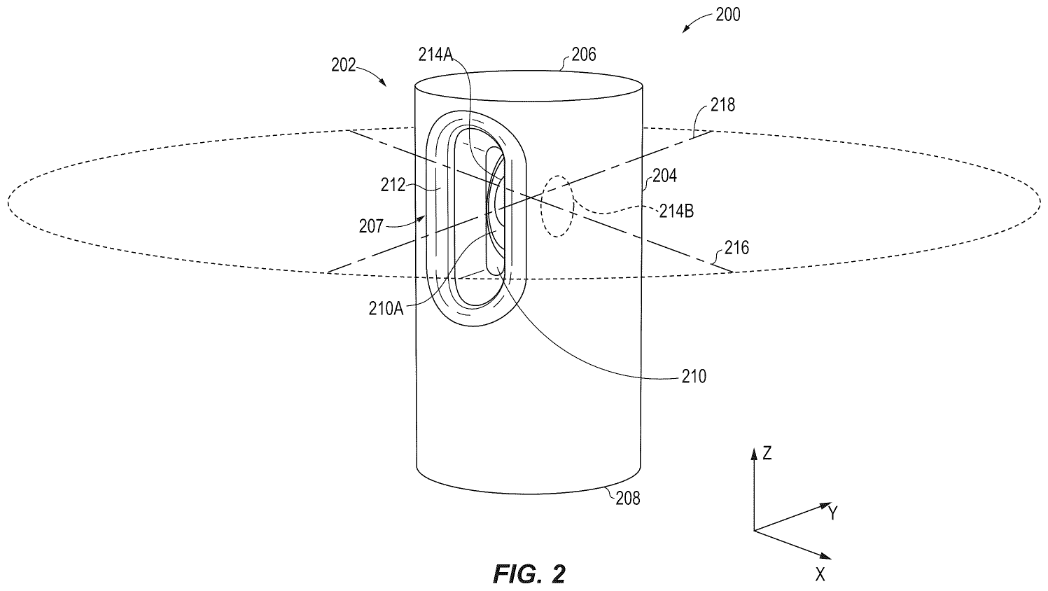

To address these issues, the present disclosure provides a speaker assembly that includes a plurality of drivers in a dual-opposed configuration on opposing sides of a narrow slit shaped output region that is formed in a speaker body. However, in some embodiments of the disclosure, it is contemplated that the speaker assembly can include a single driver that is positioned within a slit shaped output region that is formed in a speaker body. It is also contemplated that the speaker assembly can include a linear array of drivers that is positioned within a slit shaped output region that is formed in a speaker body, such as a plurality of the opposing pairs of drivers that are distributed along a direction that is parallel to a slit axis (e.g., axis 218). By placing one or more drivers in this configuration, the acoustic volume of the speaker body is maximized, allowing the speaker configuration to include a design that eliminates the need to increase a device's size, or include passive radiators to achieve similar low frequency performance. Further, the slit shaped port that runs through the speaker body provides an improved, less directional sound wave dispersion pattern. It has been found that smaller speaker diaphragms will provide a wider sound wave dispersion at higher frequencies. In one example, at frequencies greater than 500 Hz, such as frequencies greater than 750 Hz, or greater than 1,000 Hz, or greater than 2,000 Hz, or greater than 3,000 Hz, or greater than 4,000 Hz. As will be discussed further below, the dispersion effect improves as the exit size and shape of slit 210 (e.g., FIG. 2) gets closer to a “point source” that has an infinitely small slit exit opening size. The slit shaped exit port configuration, which is often referred to herein as a slot, allows the audio speaker assembly 10 to generate a wider soundwave dispersion pattern for small diaphragm drivers, while still benefiting from the pressure and sensitivity advantages commonly found when using larger diaphragm drivers. In one example, the audio speaker assembly 10 can include smaller drivers, such as drivers less than about 170 mm, or less than about 70 mm, or less than about 50 mm, or less than 43 mm. Embodiments of the speaker assembly disclosed herein are characterized by a more efficient use of space resulting in more acoustic volume and therefore improved low frequency performance, as well as increased midrange sensitivity and a wider dispersion pattern controlled by the unique geometry of the slot.

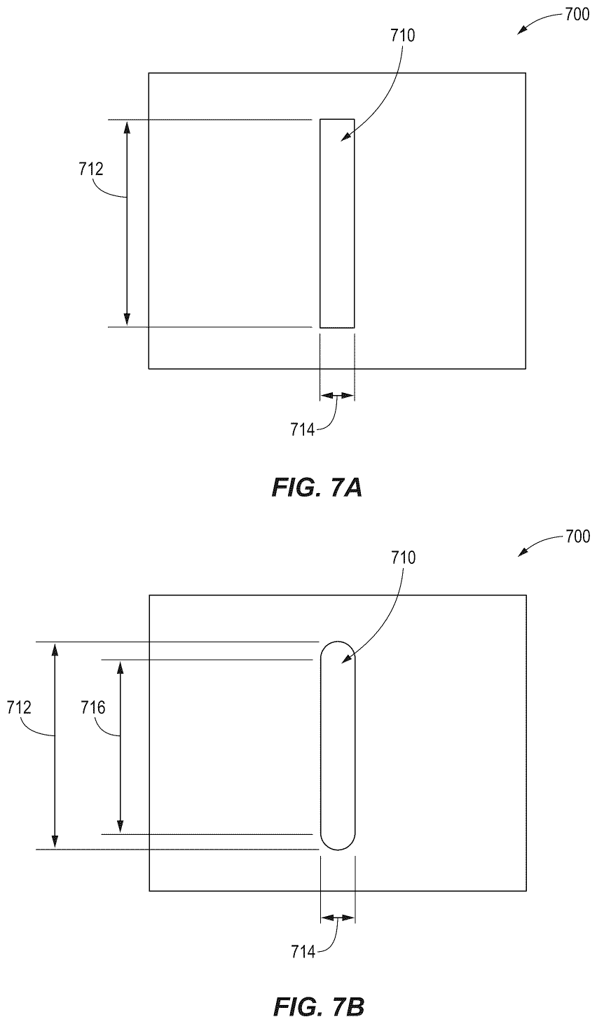

FIG. 2 illustrates an isometric view of a speaker assembly 200 of the present disclosure. The speaker assembly 200 includes a speaker body 202 having an outer surface 204 disposed between a first end cap that has a top surface 206 and a second endcap that has a bottom surface 208. In some embodiments, as shown in FIG. 2, a slit 210 extends through a portion of the outer surface 204 and includes at least one opening that has a rounded exit edge 212 (i.e., pill shaped (FIG. 7A)). The slit opening(s), which are formed at the outer surface 204, are often referred to herein as an exit port or slit exit port. In other embodiments, the slit 210 includes an opening that has a rectangular shape (FIG. 7B). A pair of drivers, e.g., a first driver 214A and a second driver 214B, are disposed within the portion of the slit 210 that is within a central portion of the speaker body 202. The slit 210 includes a slit volume 210A that is partially defined by the inner surfaces of the slit and the diaphragm of the first driver 214A and the diaphragm of the second driver 214B. The slit volume 210A is provided such that only the output side of the first driver 214A and the second driver 214B are exposed to the volume of air disposed within the slit 210. While FIG. 2 illustrates a cylindrical shaped speaker assembly design, this configuration is not intended to be limiting as to the scope of the disclosure provided herein since the speaker assembly can be formed into many different shapes, such a cube, sphere, hourglass shaped prism, oval shaped sphere, hexagonal prism, triangular prism, or other useful external shape.

As shown in FIG. 2, the first driver 214A and the second driver 214B are in a dual-opposed configuration such that the first driver 214A and the second driver 214B face each other. Further, the first driver 214A and the second driver 214B are axially aligned along a driver axis 216 that is normal to a slit axis 218 that runs along the centerline of the slit 210. As shown in FIG. 2, the centerline of the slit 210 extends through the slit's exit port 207. Additionally, in some embodiments, the first driver 214A and the second driver 214B should be of about the same, if not equal, size. For example, each of the first driver 214A and the second driver 214B may be between about 10 millimeters (mm) to about 500 mm, such as between about 10 mm to about 40 mm in the case of tweeters, between about 40 mm to about 100 mm in the case of midrange drivers, between about 100 mm and about 200 mm in the case of woofers, or between about 200 mm to about 500 mm in the case of subwoofers. The symmetry in size and coaxial alignment of the first driver 214A and the second driver 214B minimize undesired destructive interference of the target frequencies during operation of the speaker assembly 200. In some embodiments, it has been found that drivers that operate at frequencies greater than 200 Hz, such as greater than 500 Hz, or greater than 2,000 Hz, have significant benefits when utilizing the designs disclosed herein. However, in some embodiments, it may be desirable to include drivers that are not equal in size in an opposing relationship, as shown in FIG. 2. In general, the drivers can be configured to generate all audible frequencies from 20 Hz to 20 kHz.

The slit shaped port configuration of the slit 210 is used to control the audible characteristics of the sound waves produced by the speaker assembly 200. Sound waves are directed through one or more output ends of the slit 210, e.g., two narrow slit exit ports in the speaker body 202, prompting the dispersion of the sound waves emerging from each of these two apertures within a desired frequency range. When sound waves generated by the first driver 214A and the second driver 214B are delivered within the slit 210 of the speaker body 202, some constructive or destructive interference can occur. Constructive interference takes place when the two waves are in phase, resulting in sound pressure levels (SPLs) higher than that of a single driver. On the other hand, destructive interference occurs when the waves are out of phase, leading to reduced or even complete silence in certain areas of the pattern. However, the dispersion of the generated sound waves is enhanced by the slit configurations disclosed herein due at least in part to the slit being significantly narrower than the generated sound wavelengths, which is believed to create a diffraction related effect that enhances the sound dispersion pattern.

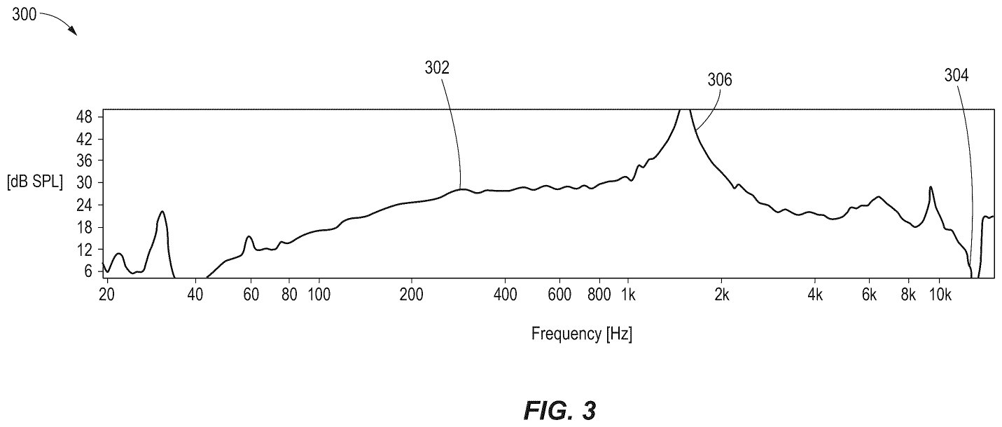

Due to the omnidirectional nature of sound waves generated at low frequencies, such as frequencies provided by sub-woofer types of drivers (e.g., <120 hertz (Hz)), the interference and dispersion effect or benefits created by the use of the double driver slit design for a subwoofer is believed to be significantly less effective than double driver slit designs that utilize mid-range and especially high frequency drivers (e.g., tweeters). It has been found that it is common for the output speakers in the high frequency range, such as greater than about 2,000 Hz, such as 8,000 Hz, or greater than 9,000 Hz, to routinely include frequency ranges where the generated sound level significantly drops off, which reduces the sound reproduction quality of the speaker assembly at these high frequencies. However, it has been found that the design can be used to greatly enhance the dispersion of the sound waves at the mid- and high-frequencies. In one example, as shown in FIG. 3, an acoustical frequency response 302 of a driver, which is often viewed by plotting sound pressure level (SPL) versus frequency, e.g., the sound pressure level plot 300, includes a significant drop off 304 in the high frequency range between about 9,500 Hz and about 16,000 Hz, which can be shifted towards higher frequencies by adjusting at least one of the slit width, slit height, slit length, and one or more edge radii as will be discussed further below. Separately, it is also desirable to control the characteristics of the double driver slit design so that one or more resonance peaks, such as the resonance peak 306 found in the frequency range between about 1,000 Hz and 2,500 Hz shown in FIG. 3, are eliminated, minimized or positioned within a desired audible frequency range so that equalization (EQ) related settings can be used to compensate for the magnitude of the resonance peak at the various resonance frequencies. As such, the sizing of the slit 210 in a double driver slit design should be adjusted to dimensions which provide or support the desired frequency response of the speaker system output. The slit 210 then allows for improved control of sound dispersion (sound distribution), improved bass response, and reduced distortion at high frequencies.

Additionally, since the pair of drivers 214A, 214B face each other and inward, a grill is not required in the speaker assembly 200 since the pair of drivers 214A, 214B will inherently be protected by the speaker body 202, reducing the complexity of the design. In alternative embodiments, a small grill may be used at the slit exit ports 207A, 207B if a fabric is wrapped around the speaker body 202. With first driver 214A and the second driver 214B in a dual-opposed configuration along the slit 210, there is an increase in space efficiency compared to outward facing dual-opposed configurations, which increases the internal net acoustic volume of the speaker system, and may eliminate the need for passive radiators in the speaker assembly 200.

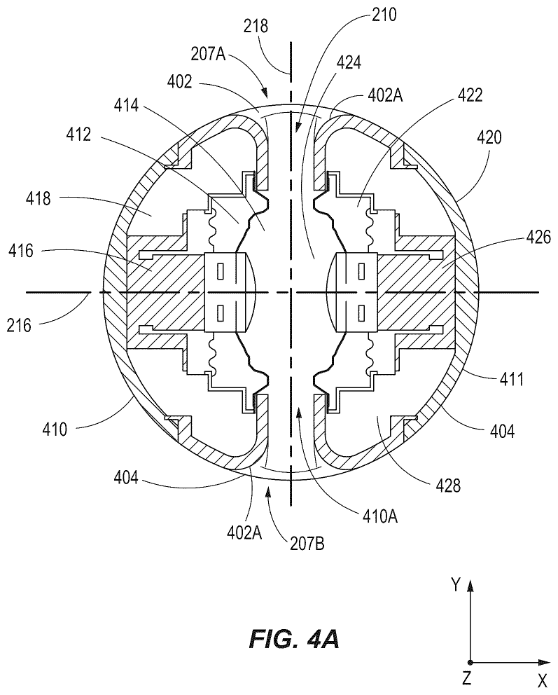

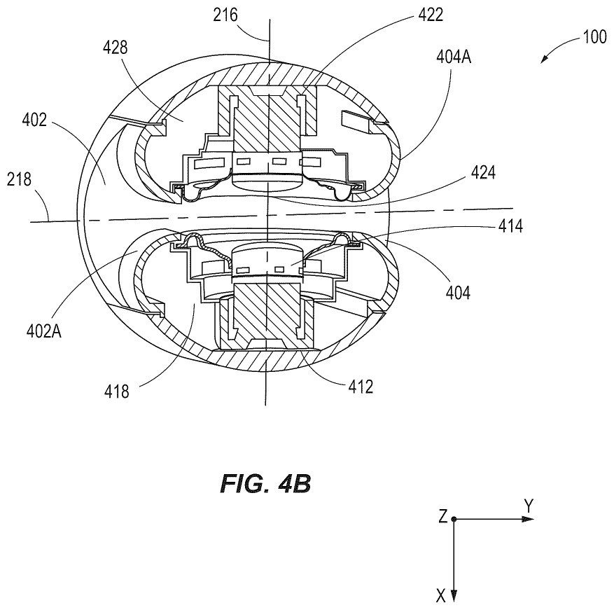

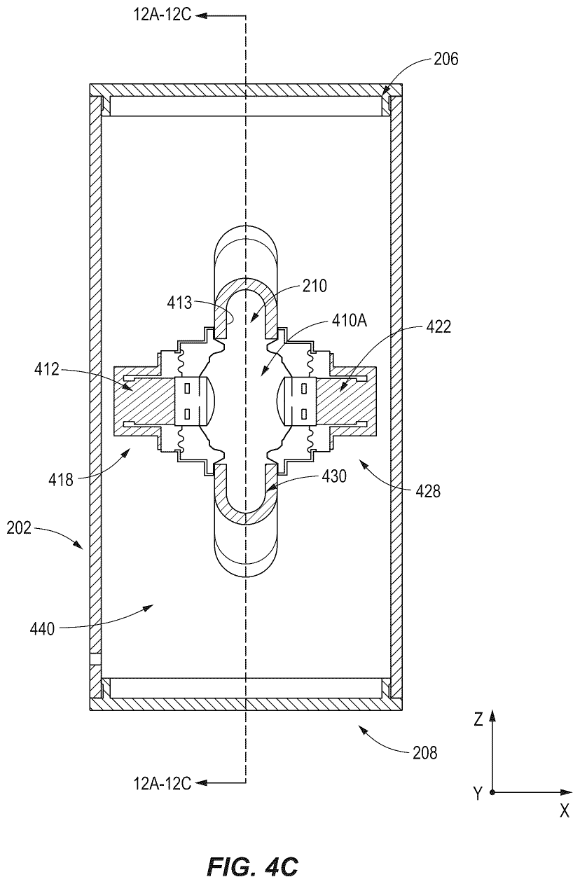

FIG. 4A illustrates a schematic, cross-sectional top view of the speaker assembly 200 that is formed by sectioning the speaker assembly 200 using an X-Y-plane that includes axis 216 and axis 218 illustrated in FIG. 2. FIG. 4B illustrates a schematic, perspective view of the schematic, cross-sectional top view of the speaker assembly 200. The slit 210 includes a first slit end 402 and a second slit end 404 disposed coaxially along a slit axis 218 on opposing sides of the outer surface 204. A first slit exit port 207A is formed at the first slit end 402 and a second slit exit port 207B is formed at the second slit end 404. The speaker body 202 includes a first side 410 and a second side 420 on opposing ends of the slit 210. A first driver 412 having a first front end 414 and a first back end 416 is disposed within a first volume 418 disposed on a first side 410. Similarly, a second driver 422 having a second front end 424 and a second back end 426 is disposed within a second volume 428 disposed on the second side 420. In some embodiments, the first volume 418 and the second volume 428 are in direct communication with each other, and form an inner volume 440 (FIG. 4C) of the speaker assembly 200. The double driver slit design disclosed herein allows the volumes 418 and 428, and thus the inner volume 440, to be increased over volumes that can be created in a conventional design, which includes the drivers facing outward and in opposite directions. The opposing orientation of the drivers in the double driver slit design disclosed herein eliminates the need for flat exterior surface mounting regions that are required to mount the driver to the speaker body 202 in the conventional design, which would push the driver towards the center of a cylindrical structure and reduce the useable acoustic volume within the speaker body 202. The first driver 412 and the second driver 422 are coaxially aligned along a center axis 216 that is perpendicular to the slit axis 218. The first front end 414 of the first driver 412 and the second front end 424 of the second driver 422 are adjacent to and, as shown, disposed within the slit 210, each of the first front end 414 and second front end 424 are facing each other and the slit volume 410A of the slit 210. In some embodiments, the first slit end 402 includes a first slit radius 402A which transitions from the slit volume 410A region of the slit 210 to an outer surface 411 of the speaker body 202 to provide a transition for air flow through the slit 210. Similarly, the second slit end 404 can include a second slit radius 404A that matches the first slit radius 402A.

The speaker assembly 200 so configured improves space efficiency and internal acoustic volume compared to outward facing dual-opposed configurations (e.g., FIG. 1C) for the same external device shape and dimensions. This reduces the potential need to require passive radiators to achieve the same acoustic performance, creating a less expensive speaker, as passive radiators necessitate meticulous design and tuning for proper functionality. Alternatively, passive radiators could be included in the design to benefit from the increased acoustic volume, therefore increasing the bass output performance over the outward facing dual-opposed design. Consequently, the speaker assembly 100 exhibits a straightforward design, simplifying the manufacturing and assembly processes.

FIG. 4C illustrates a cross-sectional side view of the speaker assembly 200 sectioned along an X-Z-plane in FIG. 2 that includes axis 216. As shown in FIG. 4C, the speaker body 202 includes the body volume 440 disposed between the top surface 206, bottom surface 208, and the slit 210. The slit 210 also includes an inner surface 413 of the slit 210 located between the ceiling or the floor of the slit and a slit volume 410A. The body volume 440 allows for necessary electrical components, such as printed circuit board, to be disposed within the speaker body 202 without interfering with the slit 210, the first driver 412, or the second driver 422.

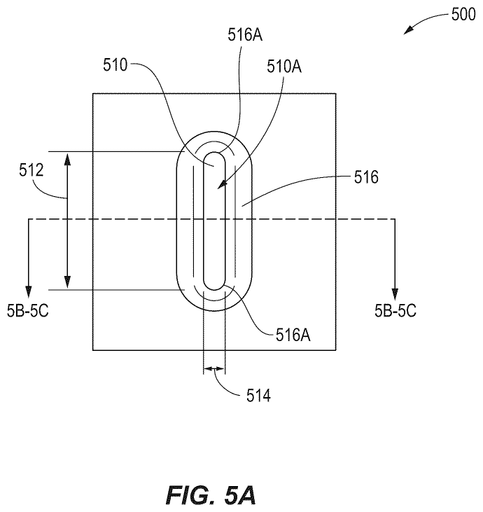

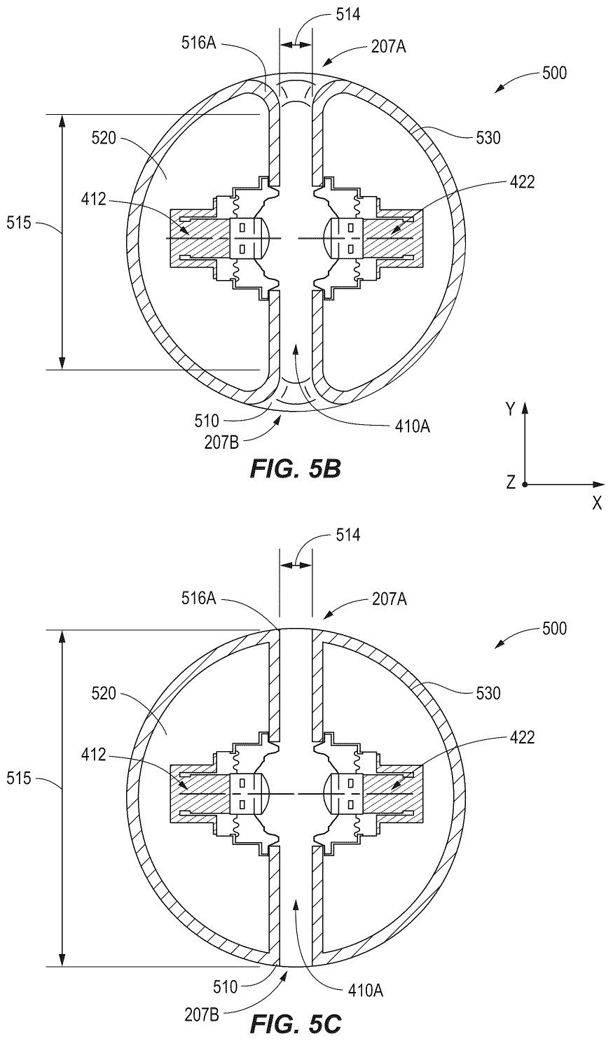

FIG. 5A illustrates a front side view of a portion of a speaker assembly 500, and in particular, a slit exit port of a slit 510 in a first configuration. As with other front views described herein, the front view is aligned with and viewed in the direction of axis 218 of FIG. 2. The slit exit port of the slit 510 in the first configuration shown in FIG. 5A has a pill shape. In general, a pill shaped slit exit port will include a slit that has arc shaped regions at opposing ends, such as semi-circular end regions as illustrated in FIGS. 2, 5A and 7B. The slit exit port includes a slit height 512, a slit width 514, and a slit volume 510A that is partially defined by inner surfaces of the slit 510 and the front ends of a pair of drivers (not shown). The slit width 514 is selected to provide adequate air flow without restriction through the slit which is dependent on the frequency generation characteristics and/or diameter of the drivers disposed therein and may be between about 5 mm and about 200 mm, such as between about 10 mm to about 30 mm, such as between about 15 mm to about 40 mm, such as between about 70 mm to about 200 mm. The slit height 512 should also be selected to provide adequate air flow without restriction through the slit which is dependent on the frequency generation characteristics and/or diameter of the drivers disposed therein and may be between about 5 mm and about 500 mm, such as between about 10 mm to about 30 mm, such as between about 15 mm to about 40 mm, such as between about 45 mm and 90 mm, such as between about 70 mm to about 170 mm, such as between about 190 mm to about 500 mm. In one or more embodiments, the ratio of the slit width 514 to the slit height 512 is from about 1:1 to about 1:500, such as about 1:20 to about 5:6, such as from about 1:15 to about 3:4, such as from about, 1:10 to about 3:4, such as from about 1:9 to about 2:3. In some embodiments, the slit height 512 is less than or equal to the diameter of the drivers 412, 422. In other embodiments, the slit height 512 is a small or nominal distance taller than the diameter of the drivers, such as about +/−5 mm larger than the diameter of the drivers. Alternatively, in some applications, the slit height 512 can be selected to be significantly larger than the driver's diameter, such as between 1 and 10 times larger than the driver's size to eliminate or avoid design and/or tuning challenges involving the resonance frequency of the slot.

The audible output created by the driver-generated acoustic waves traveling through and emanating from the slit exit port of the slit 510 are influenced by its dimensions or characteristics, e.g., the slit height 512, the slit width 514, the slit length 515 and the slit's edge profile (e.g., shape, radii, etc.) found at the exit of the slit 210. As noted above, the ability of the generated sound waves to propagate through the slit is affected by the slit width 514 and slit height 512. When the slit width 514 is larger than the wavelength, the acoustic waves pass through the slit width 514 and experience minimal diffraction and thus dispersion, if any, into the environment. When the slit width 514 is smaller than the wavelength, more diffraction occurs and the greater the dispersion of the acoustic waves. Similarly, the diffraction of acoustic waves is impacted by the slit height 512. A taller slit diminishes diffraction, while a shorter one augments it. As will be described in more detail below, the narrower the slit width 514 and the smaller the slit height, the better the 360° dispersion performance (omni-directivity) of the audible output of the speaker assembly 500. Additionally, the dimensions of the slit height 512 and slit width 514 may be determined as a ratio to the frequency the drivers generate. For example, the ratio of the slit height 512 to the driver diameter may be in a range between 1:10 or 10:1, such as 2:1, 1:1, 1:2, or 1:3. Similarly, the ratio of the slit width 514 to the driver diameter may be in a range between 2:1 or 1:50, such as 2:1, 1:1, 1:2, or 1:3. In one example, the ratio of the slit height 512 to the driver diameter may be in a range between 1:10 and 10:1 and the ratio of the slit width 514 to the driver diameter may be 2:1 and 1:50. In some embodiments, it is desirable to form a speaker assembly where the ratio of the geometry of the slit and the wavelength of the frequencies generated by the driver are related to improve the device sound performance. In one or more embodiments, the ratio of the slit width 514 to the slit height 512 is from about 1:1 to about 1:500, such as about 1:20 to about 5:6, such as from about 1:15 to about 3:4, such as from about, 1:10 to about 3:4, such as from about 1:9 to about 2:3.

An edge profile 516 that includes a slot corner 516A that is curved and disposed along the perimeter of the slit exit port of the slit 510 on the outer surface 204. The edge profile 516 of the slit 510 may be designed to balance the 360° dispersion performance and frequency sensitivity. For example, if the edge profile 516 includes a radius that is smaller in size, with a faster transition, the 360° dispersion performance of the speaker improves while the frequency sensitivity of the speaker assembly 500 decreases, and variations in sound level in the higher frequency range based on a user's position relative to the speaker assembly 500 decrease. Further, it is believed that higher turbulence based noise can be generated when sharper edge transitions are used as air flows from the slit 510 to the environment. In contrast, if the edge profile 516 includes a radius that is larger and more gradual (i.e. less sharp), the 360° dispersion performance of the speaker improves while the frequency sensitivity of the speaker assembly 500 decreases, and variations in sound level in the higher frequency range based on a user's position relative to the speaker assembly 500 decreases while the frequency sensitivity improves and turbulent noise decreases due to a more laminar flow of air through the slit 510 to the environment.

FIG. 5B illustrates a simplified cross-sectional top view of the speaker assembly 500 that is formed by use of a section line 5B-5C shown in FIG. 5A. As shown in FIG. 5B, the speaker assembly 500 includes a first side volume 520 and a second side volume 530 on either side of the slit 510. The first side volume 520 and the second side volume 530 are defined by the outer surface 204, the slit 510, and the edge profile 516. The slit 510 in the speaker assembly 500 will also include a slit length 515, which is defined between the start of the edge radii found on opposing ends of the slit 510, as shown in FIG. 5B. The first side volume 520 and the second side volume are defined by the outer surface 204, the top surface 206, the bottom surface 208, the slit height 512, the slit width 514, slit length 515, and the edge profile 516. As the slit 510 is tuned, e.g., slit height 512 and slit width 514 are adjusted to achieve desired performance, the acoustic volume of the speaker assembly 400 shifts as well.

In one or more examples, the slit 510 includes an edge profile 516 that includes a slot corner 516A (FIG. 5B) that is disposed along the perimeter of the slit exit port of the slit 510 on the outer surface 204. The edge profile 516 of the slit 510 may be designed to balance the 360° dispersion performance and frequency sensitivity. For example, if the edge profile 516 includes a radius shaped feature that is smaller in size, faster transition, the 360° dispersion performance of the speaker improves while the sensitivity of the speaker assembly 500 decreases. Further, it is believed that higher turbulence based noise can be generated when sharper edge transitions are used in the exit geometry of the slit 510 to the environment. In contrast, if the edge profile 516 is larger and more gradual, the 360° dispersion performance of the speaker decreases while the frequency sensitivity improves and turbulent noise decreases due to a more laminar flow of air through the exit geometry of the slit 510 to the environment.

FIG. 5C illustrates a simplified cross-sectional top view of the speaker assembly 500 in a second configuration in which the slot corner 516A of the edge profile 516 has a sharp edge (i.e., a sharp exit geometry). As will be shown in more detail below the cross-sectional shape and shape of the slot corner of a slit has an effect on the 360° dispersion performance of the audible output provided by the speaker assembly 500.

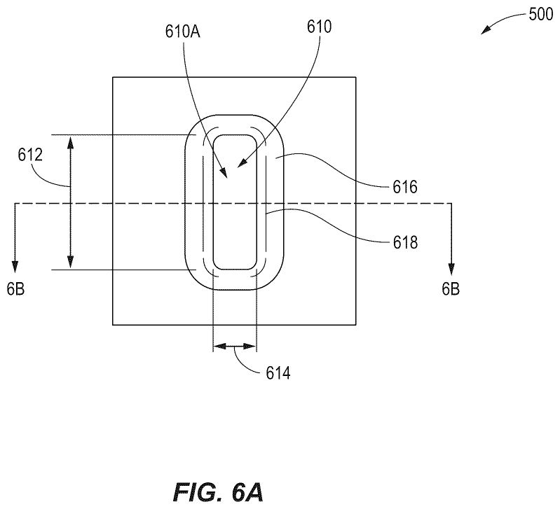

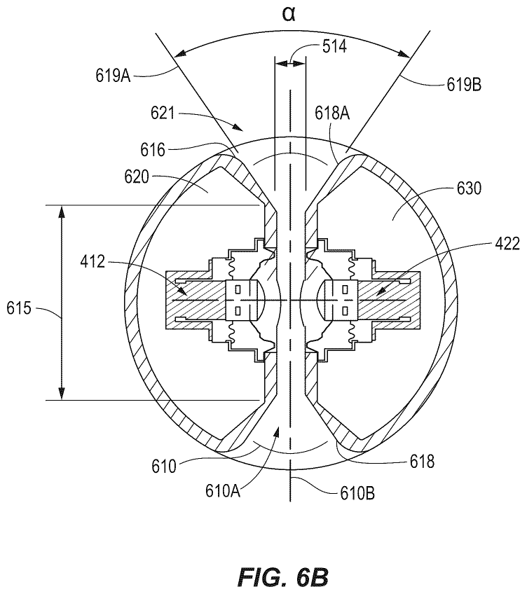

FIG. 6A illustrates a front side view of a portion of a speaker assembly 600, and in particular, a slit exit port of a slit 610 in a second configuration. The slit exit port of the slit 610 includes a slit height 612, a slit width 614, and a slit volume 610A partially defined by inner surfaces of the slit 610 and the diaphragms of a pair of drivers (not shown). The slit width 614 should be sized in relation to the frequency generation characteristics of the drivers disposed therein and may be between about 1 mm and about 200 mm, such as about 1 mm to about 40 mm, such as between about 10 mm to about 40 mm, such as between about 70 mm to about 170 mm, such as between about 190 mm to about 200 mm. The slit height 612 should also be selected to provide adequate air flow without restriction through the slit which is dependent on the frequency generation characteristics and/or diameter of the drivers disposed therein and may be between about 1 mm and about 500 mm, such as between about 10 mm to about 40 mm, such as between about 15 mm to about 40 mm, such as between about 45 mm and 90 mm, such as between about 70 mm to about 170 mm, such as between about 190 mm to about 500 mm. In one or more embodiments, the ratio of the slit width 614 to the slit height 612 is from about 1:1 to about 1:500, such as about 1:20 to about 5:6, such as from about 1:15 to about 3:4, such as from about, 1:10 to about 3:4, such as from about 1:9 to about 2:3.

The audible output created by the driver generated acoustic waves traveling through the slit 610 are similarly influenced by characteristics of the draft angle containing slit 610, such as the slit height 612, the slit width 614, the slit length 615, and the slit's edge profile found at the exit of the slit 610. As discussed above in relation to FIGS. 5A-5B, the ability of the generated sound waves to propagate through the slit 610 is affected by the slit width 614 and slit height 612. As will be described in more detail below, the narrower the slit width 614, and the smaller the slit height 612, the better the 360° dispersion performance of the audible output of the speaker assembly 600.

As such, the dimensions of the slit height 612 and slit width 614 may be determined as a ratio that is related to the frequency generation characteristics of drivers used therein. However, additionally, the flare rate, or draft angle, of the draft walls 618 (FIG. 6B) can be a significant factor in determining the frequency response. The flare rate is the rate at which the draft walls 618 widen from the end of the slit length 615 to the edge profile 616. In other words, the flare rate is directly related to the draft angle 618A and the length of the draft walls 618. The larger the draft angle 618A and the shorter the draft walls 618, the higher the flare rate. The length of the draft walls 618 also affects the frequency response. Longer draft walls 618 will have lower cutoff frequency and a narrower directivity pattern, while shorter draft walls 618 will have higher cutoff frequency and a wider dispersion pattern. Accordingly, the flare rate and the length of the draft walls 618 may be determined as a ratio to the wavelength of the frequencies produced by the drivers therein. For example, the ratio of the flare rate to the driver diameter may be 2:1, 1:1, 1:2, or 1:3. Similarly, the ratio of the length of the draft walls 618 to the driver diameter may be 2:1, 1:1, 1:2, or 1:3.

The edge profile 616 is disposed along the perimeter of the slit exit port of the slit 610 on the outer surface 204. The edge profile 616 of the slit 610 may be designed to balance 360° dispersion performance and frequency sensitivity. For example, if the edge profile 616 is a smaller (e.g., smaller radii), faster transition as in FIGS. 5A-5B, the 360° dispersion performance of the speaker improves while the frequency sensitivity of the speaker assembly 600 decreases. In contrast, if the edge profile 616 is larger and more gradual (e.g., larger radii) and includes a pair of draft walls 618 between the edge profile 616 and the inner portion of the slit 610, that further promotes acoustic impedance matching and a more laminar flow of air through the slit 610 to the environment and the frequency sensitivity increases.

FIG. 6B illustrates a simplified cross-sectional top view of the speaker assembly 600 that is formed by use of a section line 6B-6B shown in FIG. 6A. As shown in FIG. 6B, the speaker assembly 600 includes a first side volume 620 and a second side volume 630 on either side of the slit 610. The first side volume 620 and the second side volume 630 are defined by the outer surface 204, the slit 610, and the edge profile 616. As noted above, the edge profile 616 includes draft walls 618 on each side of the slit 610 at the first side volume 620 and the second side volume 630. The draft walls 618 are at a draft angle 518A from a center axis 510B of the slit 510 and promote a more laminar flow of air emanating from the slit 610 due to the motion of the drivers 412, 422. The draft angle 618A determines the length required of the draft walls 618 meaning that the larger the draft angle 618A is, the longer the draft walls 618 are required to be to achieve such an angle. The increase in the overall size of the slit 610, e.g., the more gradual transition from the slit to the environment either by a large edge radius 616A, a large draft angle 618a, or a combination of both, also reduces the acoustic volume of the first side volume 620 and the second side volume 630 equally. Thus, the larger the slit 610 and larger the draft angle 618A is, the less acoustic volume is available in the speaker assembly 600. The slit 610 in the speaker assembly 600 will also include a slit length 615, which is defined between the start of the draft walls 618 found on opposing ends of the slit 510, as shown in FIG. 6B.

The edge profile 616 and the draft walls 618 define an exit edge 621 of the slit 610 (i.e., an exit edge). The draft angle 618A causes the exit edge of the slit 610 to have a chamfer shape. The exit edge 621 of the slit 610 has an exit angle α. The exit angle α is measured between lines 619A and 619B that are tangent to the draft walls 618. As will be described in more detail below, the edge profile 616 and the exit angle α affects the 360° dispersion performance of the speaker assembly 600. As will be described in more detail below, the sharper the edge profile 616, the better the 360° dispersion performance (the omni-directivity) of the speaker assembly 600. For example, the edge profile 516 having slot corners 516A that are sharp, as shown in FIG. 5C, would have a better 360° dispersion performance. However, a chamfer shape (i.e., an edge profile 616 having with the exit edge 621) may smooth out treble frequencies in the audible output of a speaker assembly. The smaller the exit angle α, the better the 360° dispersion performance of the speaker assembly 600. In one or more embodiments, the exit angle α is from about 1 degree to about 90 degrees.

FIG. 7A illustrates a front side view of a speaker assembly 700, and in particular, a slit exit port of a slit 710 in a first configuration. The slit exit port of the slit 710 in the first configuration shown in FIG. 7A has a rectangular shape with a sharp (or hard edge) where the slit 710 meets the exterior surface of the speaker assembly 700. The slit 710 includes a slit height 712, a slit width 714, and a slit volume 710A partially defined by inner surfaces of the slit 710 and the front ends of a pair of drivers. The slit width 714 should be selected to provide adequate air flow without restriction through the slit which is dependent on the volumetric displacement of the drivers disposed therein and may be between about 1 mm and about 500 mm, such as between about 1 mm to about 30 mm, such as between about 15 mm to about 40 mm, such as between about 70 mm to about 170 mm, such as between about 190 mm to about 500 mm. The slit height 712 should also be selected to tune the resonance of the slit, by shifting the center frequency of the resonance of the slit to a more desirable frequency depending on performance targets of the slit, and provide adequate air flow without restriction through the slit which is dependent on the frequency generation characteristics and/or diameter of the drivers disposed therein and may be between about 5 mm and about 500 mm, such as between about 10 mm to about 30 mm, such as between about 15 mm to about 40 mm, such as between about 45 mm and 90 mm, such as between about 70 mm to about 170 mm, such as between about 190 mm to about 500 mm As will be described in more detail below, the narrower the slit width 714 and the smaller the slit height 712, the better the 360° dispersion performance of the audible output of the speaker assembly 700. In one or more embodiments, the ratio of the slit width 714 to the slit height 712 is from about 1:1 to about 1:500, such as about 1:20 to about 5:6, such as from about 1:15 to about 3:4, such as from about, 1:10 to about 3:4, such as from about 1:9 to about 2:3. In one example, the ratio of the he slit width to the slit height is between 1:4 and 1:20.

FIG. 7B illustrates a front side view of a speaker assembly 700, and in particular, a slit exit port of a slit 710 in a second configuration. The slit 710 in the second configuration shown in FIG. 7B has a pill shape including a shaped edge. The slits 710 illustrated in FIGS. 7A and 7B will be described in greater detail below.

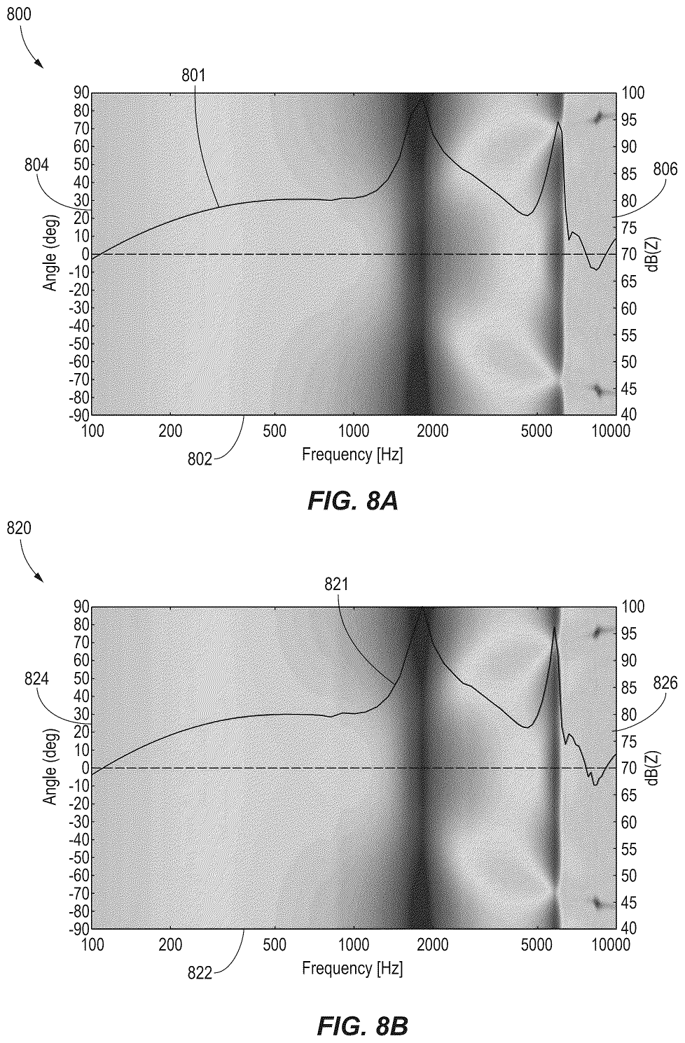

FIG. 8A illustrates a graph illustrating the audible output of a speaker assembly according to one or more embodiments. The graph 800 illustrates the audible output of the speaker assembly 500 with the slit 510 in the first configuration and/or the speaker assembly 700 with the slit 710 in the second configuration. Stated differently, the graph 800 represents when the slit 510 and the slit 710 have a pill shape, as shown in FIG. 5A and FIG. 7B, respectively. The graph 800 includes an axis 802 that represents the frequency of the audible output of the speaker assembly 500 with the slit 510 in the first configuration and/or the speaker assembly 700 with the slit 710 in the second configuration. An axis 804 of the graph 800 illustrates an angle between the driver axis 216 that is normal to the slit axis 218 that runs along the centerline of the slits 510, 710 and a user. The graph 800 includes a line 801 that illustrates a single simulated frequency response. The line 801 illustrates the frequency response directly in front of the speaker assemblies 500, 700 (i.e., slit 510 and slit 710). Therefore, the graph 800 is a heat map illustrating the change of the sound intensity in dB (sound pressure level) of the audio output of the speaker assembly 500 with the slit 510 first configuration and/or the speaker assembly 700 with the slit 710 in the second configuration at different angles between the driver axis 216 and a user across different frequencies.

### Audio Speaker Assembly Examples

FIGS. 8A-8B, 9A-9B, 10A-10B, and 11A-11C include color heat maps that are intended to illustrate the effects of altering the various characteristics of slit and/or driver combinations, according to one or more embodiments of the disclosure provided herein. As shown in FIGS. 8A-11C the magnitude of the SPL is illustrated by colors that vary from a black color (e.g., ˜40 dB), to a blue color (e.g., ˜48-52 dB), to a green color (e.g., ˜68-72 dB), to an orange color (e.g., ˜82-84 dB), to a red color (e.g., ˜92-94 dB), and finally to a dark red color (e.g., ˜98-100 dB).

In one audio speaker assembly example, as shown in FIG. 8A, the 360° dispersion performance of a speaker assembly that includes a pill shaped slit, such as speaker assembly 500 with a pill shaped slit 510 or the speaker assembly 700 with the pill shaped slit 710 (e.g., second configuration). It has been found that pill shaped slits have an improved dispersion performance over the conventional audio speaker assembly 10 configuration described in relation to FIG. 1A. The audible output of both the speaker assembly 500 with the pill shaped slit has an improved dispersion performance across multiple frequencies versus the graphs illustrated in FIGS. 1B and 1D, especially at frequencies greater than about 500 Hz. This is best illustrated by comparing the sound intensity of the audible output illustrated in FIGS. 1B-1C versus FIG. 8A. As illustrated in the graph 800 the sound intensity across each of the angles have small SPL level variations (i.e., color change) for each frequency. Stated differently, the color variation in the graph 800 is more consistent across the various angular positions (e.g., vertically on the graph) and thus illustrating an improved 360° dispersion performance. Advantageously, a user can be located at any angle relative to the speaker assembly 200 and still hear a high quality audible output from either speaker assembly configuration.

FIG. 8B illustrates a color heat map graph illustrating the audible output of a speaker assembly according to one or more embodiments. The graph 820 illustrates the audible output of the speaker assembly 500 with a rectangular shaped slit, such as the slit 510 in the second configuration or the speaker assembly 700 having the slit 710 in the first configuration as shown in FIG. 5C and FIG. 7A, respectively. The graph 820 includes an axis 822 that represents the frequency of the audible output of the speaker assembly that includes a rectangular shaped slit. An axis 824 of the graph 820 illustrates an angle between the driver axis 216 that is normal to the slit axis 218 that runs along the centerline of the slits 510, 710 and a user. The graph 800 includes a line 801 that illustrates a single simulated frequency response taken at or along the zero degree angle, and thus illustrates the frequency response directly in front of the speaker assemblies 500, 700 (i.e., slit 510 and slit 710).

As shown in FIG. 8B, the speaker assembly 500 with the rectangular shaped slit has an improved 360° dispersion performance when compared to the audio output of the audio speaker assembly 10 illustrated in FIGS. 1B and 1D, especially at frequencies greater than about 500 Hz. As illustrated in the graph 820, for the most part, the sound intensity of the audible output across each of the angles is consistent for each frequency. Stated differently, the coloration in the graph 800 is more consistent across the various angular positions (e.g., vertically on the graph) and thus illustrating an improved 360° dispersion performance. Advantageously, a user can be located at any angle relative to a speaker assembly 200 and still hear a high quality audible output from either speaker assembly.

Furthermore, the graph 800 and the graph 820 show that the frequency response of a pill shaped slit is improved (smoother) versus a rectangular shaped slit. Stated differently, the line 801 is smoother than the line 821 indicating an improvement in the frequency response of a pill shaped slit.

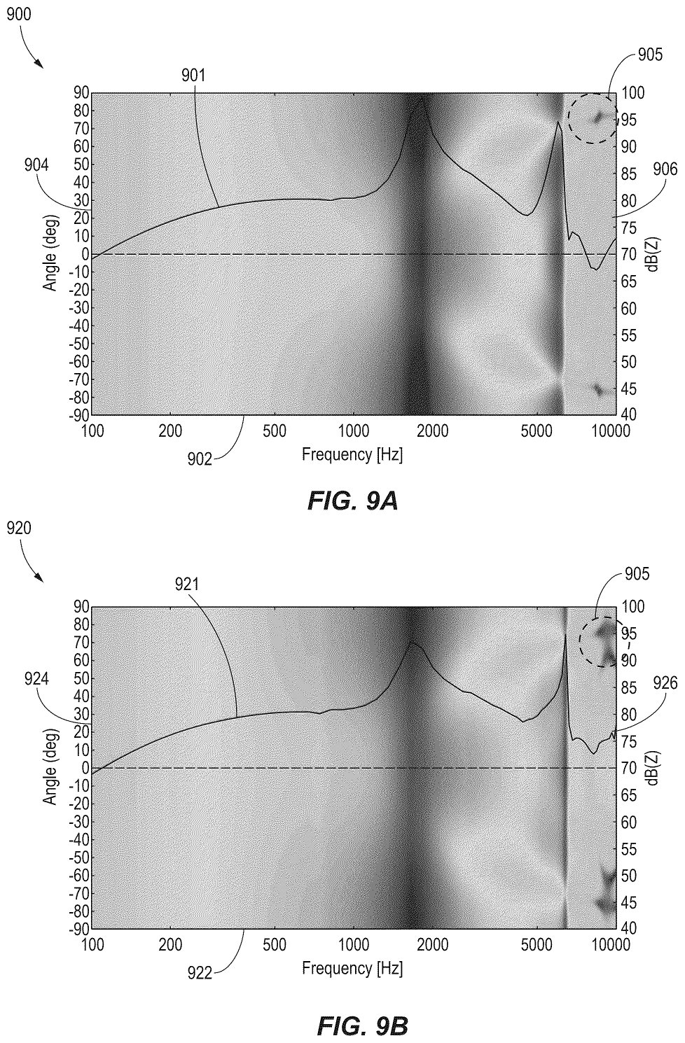

Additionally, as noted above, the width of the slit (e.g., slits, 210, 510, 610, 710) has an effect on the 360° dispersion performance of a speaker assembly. As will be discussed further below, in general, the smaller a slit width (i.e., slit widths 514, 614, and 714) in any slit configuration the better the 360° dispersion. FIG. 9A illustrates a graph 900 illustrating the audible output of a speaker assembly having a slit with a first slit width, such as about 10 mm. FIG. 9B illustrates a graph 920 illustrating the audible output of a speaker assembly having a slit with a second slit width, such as about 30 mm. The first slit width is smaller than the second slit width.

The graph 900 includes an axis 902 that represents the frequency of the audible output of a speaker assembly (e.g., speaker assemblies 500-700) with a slit having the first slit width. An axis 904 of the graph 900 illustrates an angle in the horizontal plane relative to the slit axis 218 that runs along the centerline of a slit having the first slit width. The graph 900 includes a line 901 that illustrates a single simulated frequency response taken at or along the zero degree angle, and thus illustrates the frequency response directly in front of the slit within a speaker assembly. Therefore, the graph 900 is a heat map illustrating the frequency response of a speaker assembly having the first slit width.

As shown in FIG. 9A, the audible output of the speaker assembly with a slit having the first slit width has a better 360° dispersion performance than audio speaker assembly 10 as illustrated by comparing FIGS. 1B and 1D and FIG. 9A. This is best illustrated by the intensity of the audible output (SPL) at frequencies greater than about 500 Hz. As illustrated in the graph 900, the sound intensity across each of the angles are consistent for each frequency (e.g., little angular variation at frequencies greater than 500 Hz). Stated differently, the color variation in the graph 900 is more consistent across the various angular positions (e.g., vertically on the graph) for each angle, illustrating the audible output is more omni-directional over a wider range of frequencies than the audio speaker assembly 10 graphs illustrated in FIGS. 1B and 1D. Advantageously, a user can be located at any angle measured with respect to the driver axis 216 and still hear a high quality audible output from the slit containing speaker assembly.

Referring to FIG. 9B, the graph 920 includes an axis 922 that represents the frequency of the audible output of a speaker assembly (e.g., speaker assemblies 500-700) with a slit having the second slit width. An axis 924 of the graph 920 illustrates an angle in the horizontal plane relative to the slit axis 218 that runs from the centerline of a slit. The graph 920 includes a line 921 that illustrates a single simulated frequency response taken at or along the zero degree angle, and thus illustrates the frequency response directly in front of the speaker assembly. Therefore, the graph 920 is a heat map that illustrates the frequency response of a speaker assembly having the second slit width.

As shown in FIG. 9B, the audible output of the speaker assembly having a slit having the second slit width advantageously has a better 360° dispersion performance than the audio speaker assembly 10 as illustrated by comparing FIGS. 1B-1C and FIG. 9B. As illustrated in the graph 920, the color variation in the graph 920 is more consistent across the various angular positions (e.g., vertically on the graph) for each angle illustrating the audible output is more omni-directional over a wider range of frequencies than the audio speaker assembly 10. Advantageously, a user can be located at any angle and still hear a high quality audible output from either of the slit containing speaker assemblies.

Furthermore, the graph 900 and the graph 920 show that the 360° dispersion performance of a speaker assembly having a slit with the first slit width (i.e., a smaller width) is better than a speaker assembly having a slit with the second slit width. In this example, the first slit width is about 10 mm and the second slit width is about 30 mm for a 33 mm sized driver. Stated differently, a slit with a smaller width has a better 360° dispersion performance than a wider slot width, especially for frequencies greater than 500 Hz, such as greater than about 5,000 Hz. For example, as shown in region 905 in the graph 900 and in the graph 920, there is a smaller change in sound intensity of the audible output of the speaker assembly at frequencies between 6,000 Hz and 10,000 Hz with the smaller (first) slit width (graph 900). Thus, a smaller slit width leads to an improvement in the 360° dispersion performance. However, as noted above the slit width of a speaker assembly is partially limited by the movement of the diaphragm of the drivers 412 and 422.

If the slot width is too narrow, it can constrain the airflow within the slot which will result in various types of distortion and thus a reduction in sound quality. Distortion is caused by direct airflow that is commonly experienced for drivers which are trying to deliver low frequency (e.g., <500 Hz) soundwaves. In some embodiments, it is desirable for a ratio between the slit width and driver diameter to be between about 2:1 and about 1:50.

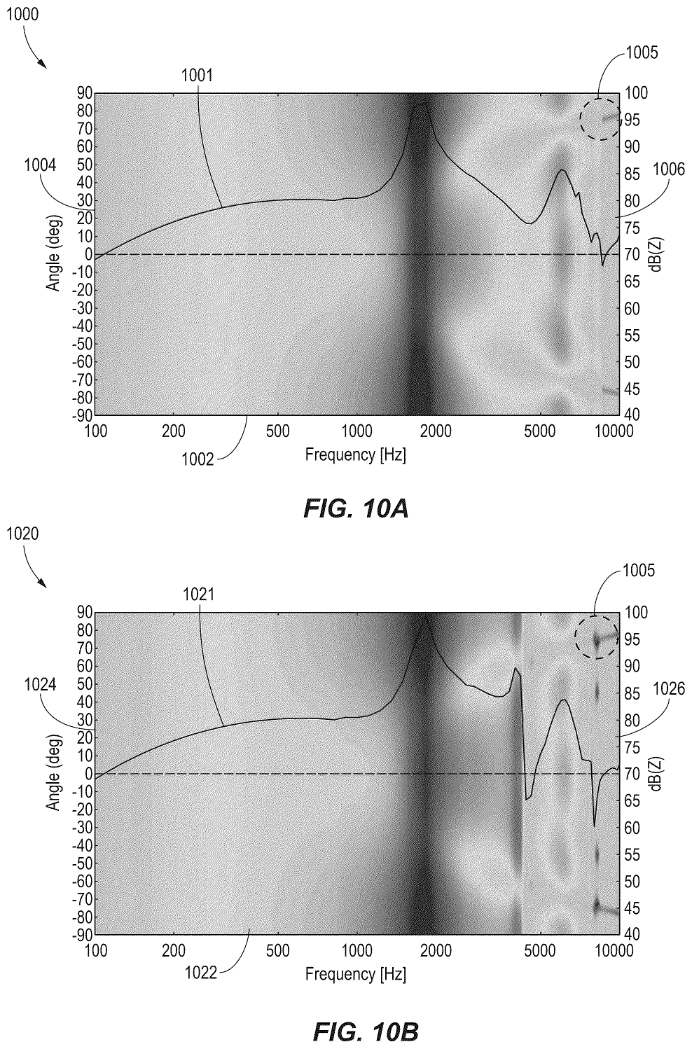

Additionally, as noted above, the height of the slit (i.e., slits, 110, 510, 610, 710) has an effect on the dispersion of the audible output of a speaker assembly. As will be discussed further below, in general, a smaller a slit height (i.e., slit heights 512, 612, and 712) in any slit configuration the better the 360° dispersion and sound quality performance. FIG. 10A illustrates a graph 1000 illustrating the audible output of a speaker assembly having a first slit height. FIG. 10B illustrates a graph 1020 illustrating the audible output of a speaker assembly having a second slit height. In this example, the first slit height is about 45 mm in height and the second slit height is about 90 mm in height for a 33 mm sized driver. The first slit height is smaller than the second slit height.

The graph 1000 includes an axis 1002 that represents the frequency of the audible output of a speaker assembly with a slit having the first slit height. An axis 1004 of the graph 1000 illustrates an angle in the horizontal plane relative to the slit axis 218 that runs along the centerline of a slit having the first slit height. The graph 1000 includes a line 1001 that illustrates a single simulated frequency response taken at or along the zero degree angle, and thus illustrates the frequency response of a speaker assembly having the first slit height.

As shown in FIG. 10A, the audible output of the speaker assembly with a slit having the first slit height has a better 360° dispersion performance across multiple frequencies than the audio speaker assembly 10 as illustrated by comparing FIGS. 1B and 1D and FIG. 10A. As illustrated in the graph 1000, the sound intensity of the audible output shown in graph 1000 across each of the angles have small variations in SPL for each frequency. Stated differently, the color variation in the graph 1000 is more across the various angular positions (e.g., vertically on the graph) for each angle at a given frequency, showing the audible output is more omni-directional over a wider range of frequencies than the audio speaker assembly 10 graphs illustrated in FIGS. 1B and 1D. Advantageously, a user can be located at any angle and still hear a high quality audible output from a slit containing speaker assembly.

Referring to FIG. 10B, the graph 1020 includes an axis 1022 that represents the frequency of the audible output of a speaker assembly (e.g., speaker assemblies 500-700) with a slit having the second slit height. An axis 1024 of the graph 1020 illustrates an angle that is measured relative to the centerline of a slit having the second slit height. The graph 1020 includes a line 1021 that illustrates a single simulated frequency response taken at or along the zero degree angle, and thus illustrates the frequency response of a speaker assembly having the second slit height.

As shown in FIG. 10B, the audible output of the speaker assembly having a slit having the second slit height has a better 360° dispersion performance across multiple frequencies than the audio speaker assembly 10 as illustrated by comparing FIGS. 1B and 1D and FIG. 10B. As illustrated in the graph 1020, the sound intensity of the audible output across each of the angles have small variations in SPL for each frequency. Stated differently, the color variation in the graph 1020 is more consistent across the various angular positions (e.g., vertically on the graph) for each angle and frequency, showing the audible output is more omni-directional over a wider range of frequencies than the audio speaker assembly 10 graphs illustrated in FIGS. 1B and 1D. Advantageously, a user can be located at any angle relative to the speaker assembly 200 and still hear a high quality audible output from either slit containing speaker assembly.

The graph 1000 and the graph 1020 show that the speaker assembly having the first slit height (i.e. a smaller height) has a better 360° dispersion performance. In this example, the first slit height is about 45 mm and the second slit height is about 90 mm for a 33 mm sized driver. It has been found that a slit with a smaller height has a better 360° dispersion performance than a taller slot height, especially for frequencies greater than 500 Hz, such as greater than about 4,000 Hz. For example, as shown in region 1005 in the graph 1000 and in the graph 1020, there is a smaller change in sound intensity of the audible output of the speaker assembly at frequencies between 4,000 Hz and 10,000 Hz with the smaller (first) slit height (graph 1000). It has been found that the effect of the slit height has a greater effect on the frequency response than other slot characteristics, such as the slit width. Just as the narrower slot width is generally preferred, a shorter slit seems to perform better than taller slit designs.

As discussed above, in some embodiments, the slit height is less than or equal to the diameter of the drivers. In other embodiments, the slit height is a small or nominal distance taller than the diameter of the drivers, such as about 10 mm larger than the diameter of the drivers. In some embodiments, it is desirable for a ratio between the slit height and driver diameter to be between about 2:1 and about 1:50.

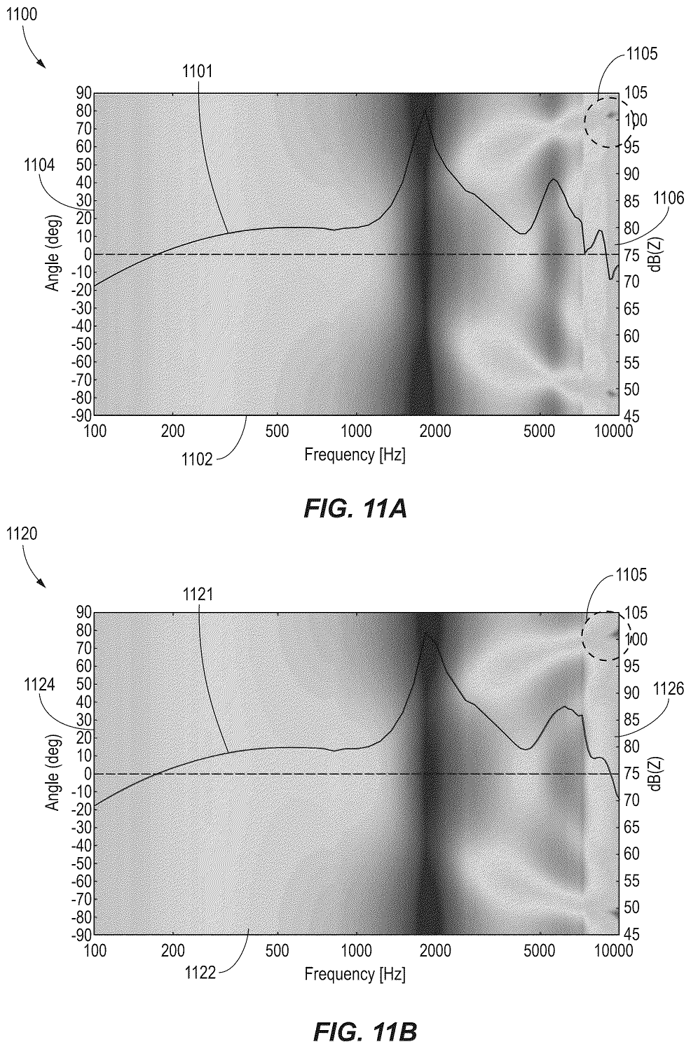

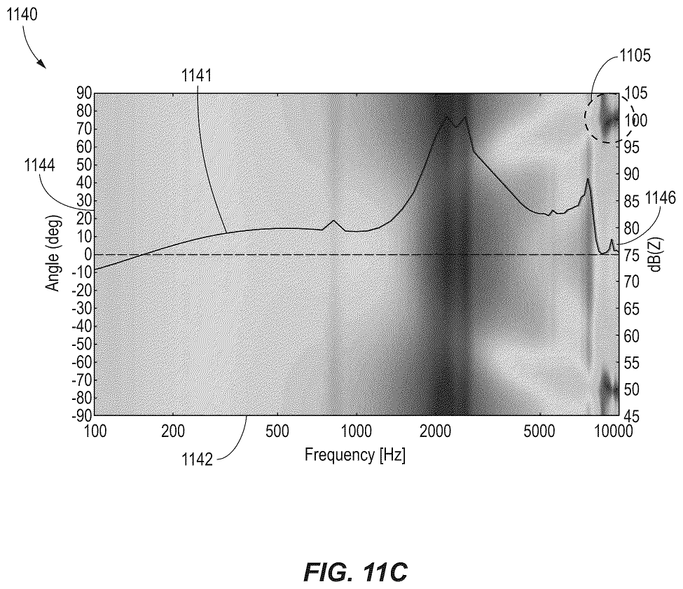

Additionally, the sharpness of an edge profile (i.e., edge profile 516 of slit 510 versus edge profile 616 of slit 610) has an effect on the 360° dispersion performance of a speaker assembly. As noted above, the sharper an edge profile the better the 360° dispersion performance. Furthermore, the exit angle α formed by an edge profile (i.e., slit 610) also has an effect on the 360° dispersion performance of a speaker assembly. FIG. 11A illustrates a graph 1100 illustrating the audible output of a speaker assembly 500 having a sharp edge profile (i.e., edge profile 516 of slit 510). FIG. 11B illustrates a graph 1120 illustrating the audible output of a speaker assembly with a chamfered edge profile and a first exit angle (i.e., exit angle α; 90 degrees). FIG. 11C illustrates a graph 1140 illustrating the audible output of a speaker assembly 600 a chamfered edge profile with a second exit angle (e.g., 90 degrees).

The graph 1100 includes an axis 1102 that represents the frequency of the audible output of the speaker assembly 500 with the slit 510 in the second configuration. Stated differently, the slit 510 includes a slot corner 516A with a sharp edge. An axis 1104 of the graph 1100 illustrates an angle that is measured relative to the centerline of the slit 510 having the second configuration. The graph 1100 includes a line 1101 that illustrates a single simulated frequency response taken at or along the zero degree angle, and thus illustrates the frequency response of the audible output of a speaker assembly 500.

As shown in FIG. 11A, the audible output of the speaker assembly 500 with the slit 510 in the second configuration advantageously has a better 360° dispersion performance across multiple frequencies than the audio speaker assembly 10 as illustrated by comparing FIGS. 1B and 1D and FIG. 11A. As illustrated in the graph 1100 the sound intensity of the audible output signal across each of the angles have small variations in SPL for each frequency. Stated differently, the color variation in the graph 1020 is more consistent across the various angular positions (e.g., vertically on the graph) for each angle and frequency, showing the audible output is more omni-directional over a wider range of frequencies than the audio speaker assembly 10 graphs illustrated in FIGS. 1B and 1D. Advantageously, a user can be located at any angle and still hear a high quality audible output from either speaker assembly.

Referring to FIG. 11B, the graph 1120 includes an axis 1122 that represents the frequency of the audible output of the speaker assembly 600 with the slit 610 having a first exit angle (exit angle α). An axis 1124 of the graph 1120 illustrates an angle that is measured relative to the centerline of the slit 610 having the first exit angle. The graph 1120 includes a line 1121 that illustrates a single simulated frequency response. The line 1121 illustrates the frequency response taken at or along the zero degree angle, and thus illustrates the frequency response of the audible output of a speaker assembly 600 having the first exit angle.

The graph 1100 and the graph 1120 show that the speaker assembly 500 having a sharp edge profile 516 has a better 360° dispersion performance. Stated differently, the speaker assembly 500 with the slit 510 in the second configuration has a better 360° dispersion performance than the speaker assembly 600 having the first exit angle. For example, as shown in region 1105 in the graph 1100 and in the graph 1120, there is a smaller change in sound intensity of the audible output for the speaker assembly with sharper edge profile. Thus, indicating there is an improvement in the 360° dispersion performance for slits with sharp edge profiles. However, as noted above, the edge profile 616 may be desirable in some situations to trade off the slight improvement in the 360° dispersion performance to smooth out treble frequencies in the audible output of the speaker assembly.

Referring to FIG. 11C, the graph 1140 includes an axis 1142 that represents the frequency of the audible output of the speaker assembly 600 with the slit 610 having the second exit angle. An axis 1144 of the graph 1140 illustrates an angle that is measured relative to the centerline of the slit 610 having the second exit angle. The graph 1140 includes a line 1141 that illustrates a single simulated frequency response taken at or along the zero degree angle, and thus illustrates the frequency response of the speaker assembly 600 having the second exit angle.

The graph 1120 and the graph 1140 show that the 360° dispersion performance of a speaker assembly 600 is improved when the slit 610 has the first exit angle (a smaller exit angle). For example, as shown in region 1105 in the graph 1120 and in the graph 1140, there is a smaller change in sound intensity for the speaker assembly 600 with the second edge angle indicating an improvement in directionality (the 360° dispersion performance). Therefore, if a curved exit profile 616 is used, the smaller the exit angle α, the better the 360° dispersion performance.

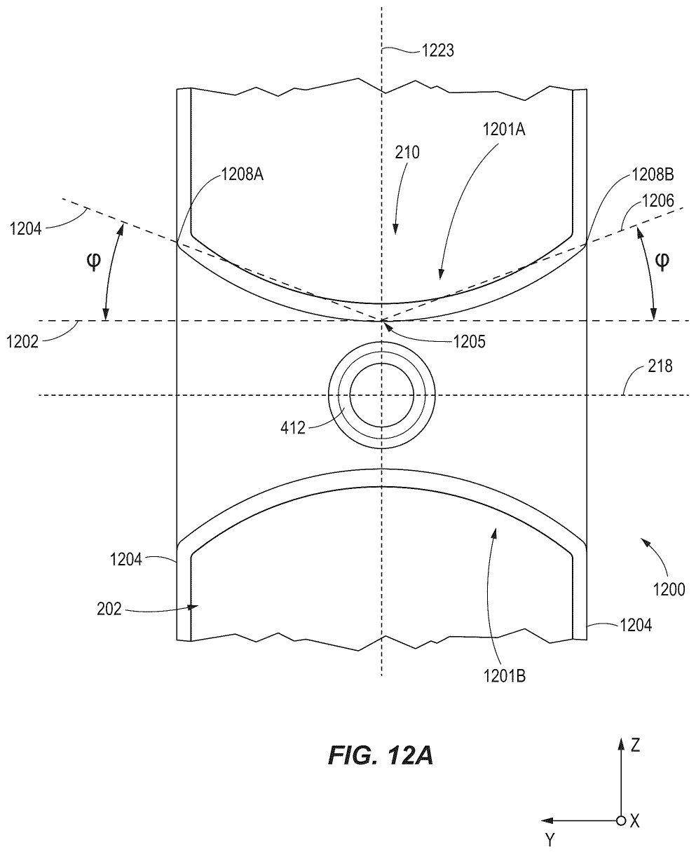

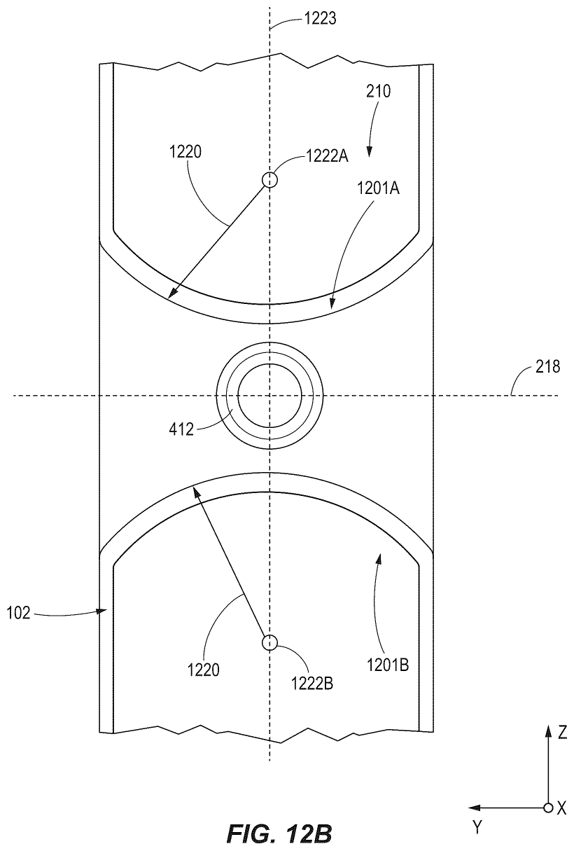

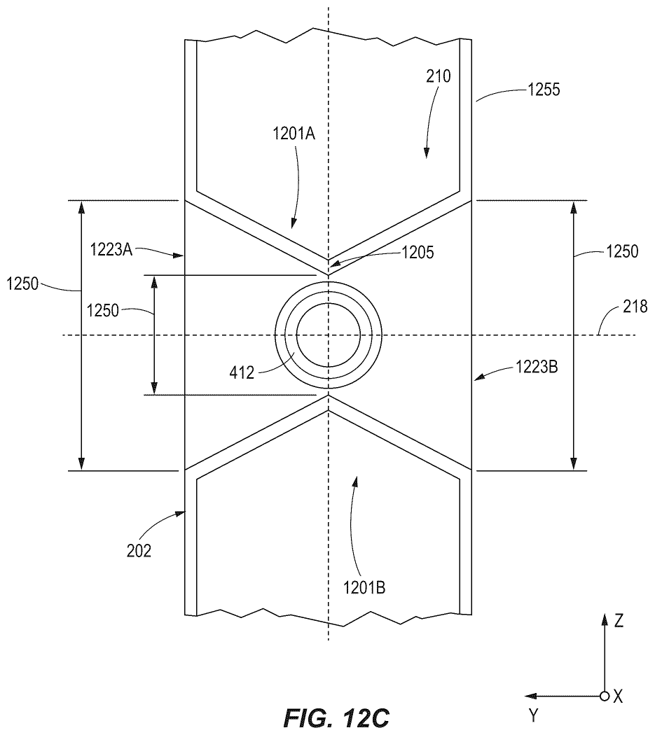

FIG. 12A illustrates a cross-sectional view of the ceiling/floor 1200 of the slit 210 of the speaker assembly illustrated in FIG. 4C in a first configuration. FIG. 12A illustrates a surface of a ceiling/floor 1200 of the speaker body 202 formed by use of a section line labeled 12A-12C in FIG. 4C. As shown in FIG. 12A, the ceiling/floor 1200 of the slit 210 (or slits 510, 610, and 710) in may be curved along a Y-Z plane that includes the slit axis 218. In one or more embodiments, the ceiling/floor 1200 of the slit 210 in the first configuration has a curved shape that is non-linear relative to the slit axis 218. The ceiling/floor 1200 of the slit 210 includes a curved portion 1201A and a curved portion 1201B. In one or more examples, the curved portion 1201A is tangential to a horizontal line 1202 positioned at a center point 1205 and is curved from the center point 1205 in both directions relative to the slit axis 218 and ends at a respective end. For example, the curved portion 1201A includes an endpoint 1208A on a first side of the center point 1205 and an endpoint 1208B on a second side of the center point 1205. The endpoints 1208A and 1208B are located on the outer surface 204 of the speaker body 202. In some configurations, the curved portion 1201A is formed so that a portion of the curved portion 1201A is tangential to outer surface 204 at a respective endpoint (not shown).

In one or more embodiments, an angle ϕ is formed between the endpoints 1208A and 1208B, and the center point 1205. The angle ϕ is measured relative to a line 1202 that is tangent to the center point 1205 and lines 1204 and 1206 that extend through each of the endpoints 1208A and 1208B, respectively. Thus the angle ϕ is measured in FIG. 12A between the line 1202 and the line 1204 or the line 1206. The angle ϕ is from 0 to about 60 degrees, such as 30° for example. In one embodiment, the surface of the ceiling/floor 1200 has a curved shape that is defined by a second order or greater shaped curve or an exponential shaped curve that extends from the center point 1205 to a respective endpoint 1208A and 1208B. In one example, the ceiling/floor 1200 includes a non-linear curve shape that follows an exponential shaped curve, which is illustrated as being formed along the sectioning plane (Y-Z-plane) created view illustrated in FIG. 12A. The exponential shaped curve can be defined by an equation Z=a*ebY, where Y is a distance along the slit axis 218 (e.g., Y-axis), “a” is a coefficient that is less than 1.0, “b” is a coefficient that is less than 1.0, and Z is a distance in a direction that is orthogonal to the slit axis 218 (e.g., Z-axis), and wherein the exponential curve extends from the center point 1205 of the internal surface to an endpoint 1208A, 1208B of the internal surface in both the −Y and +Y directions. In one example, coefficient “a” can vary in a range between 0.1 and 1.0, such as in a range between 0.5 to 1.0, and coefficient “b” can vary in a range between 0.01 and 1.0, such as between 0.01 and 0.5.

FIG. 12B illustrates a cross sectional view of the ceiling/floor 1200 of the slit 210 of the speaker assembly illustrated in FIG. 4C in a second configuration. FIG. 12B illustrates the surface of the ceiling/floor 1200 of the speaker body 202 formed by use of the section line labeled 12A-12C in FIG. 4C. As shown in FIG. 12B the ceiling/floor 1200 of the slit 210 (or slits 510, 610, and 710) may be curved relative to the slit axis 218. In one or more embodiments, the ceiling/floor 1200 of the slit 210 includes a uniform non-linear curved surface that is curved relative to the slit axis 218 and has a constant radius of curvature that is formed about a curvature point 1222A or 1222B. In one or more embodiments, the curvature points 1222A and 1222B are located along a line 1223 (e.g., a vertical line) that extends through the center point of the driver disposed within the slit.

FIG. 12C illustrates a cross sectional view of the ceiling/floor 1200 of the slit 210 of the speaker assembly illustrated in FIG. 4C in a third configuration. FIG. 12C illustrates the surface of the ceiling/floor 1200 of the speaker body 202 formed by use of the section line labeled 12A-12C in FIG. 4C. As shown in FIG. 12C the ceiling/floor 1200 of the slit 210 (or slits 510, 610, and 710) may have a chamfer shape in the third configuration. In one or more examples, in the third configuration, the surface of the ceiling/floor 1200 of the slit 210 has a first distance 1250 measured from top-to-bottom of ceiling/floor 1200 at a first end 1223A and a second end 1223B of the ceiling/floor 1200. The ceiling/floor 1200 also includes a second distance 1255 measured from top-to-bottom of the ceiling/floor 1200 that is measured between at center points (e.g., center point 1205), and also includes a linear curve that extends between the center point and the edge of the outer surface 204 at the slit exit port, thus forming a chamfer shape.

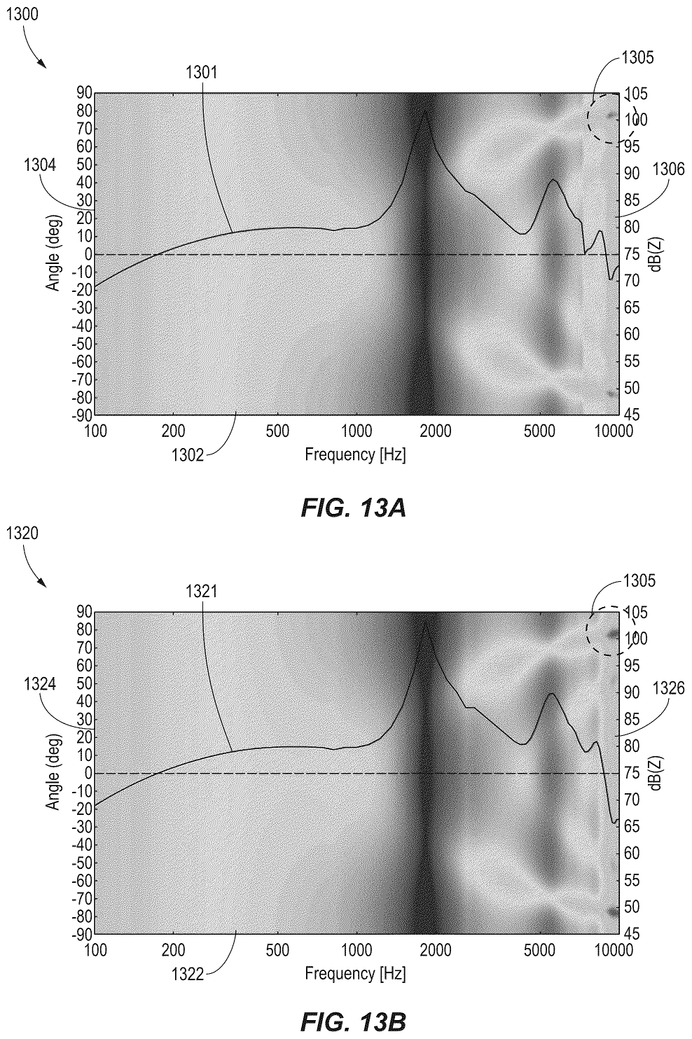

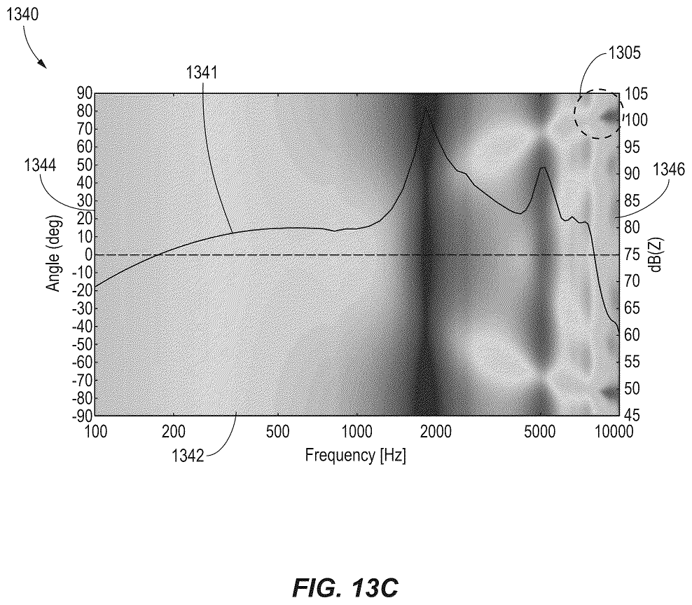

It has been found that the shape of the ceiling/floor 1200 of a slit has an effect of the 360° dispersion performance of a speaker assembly. FIG. 13A illustrates a graph 1300 illustrating the audible output of a speaker assembly having a slit having ceiling/floor 1200 with the first configuration shown in FIG. 12A. FIG. 13B illustrates a graph 1320 illustrating the audible output of a speaker assembly having a slit having a ceiling/floor 1200 with the second configuration shown FIG. 12B. FIG. 13C illustrates a graph 1340 illustrating the audible output of a speaker assembly having a slit having a ceiling/floor 1200 with the third configuration shown FIG. 12C.

The graph 1300 includes an axis 1302 that represents the frequency of the audible output of a speaker assembly with a slit having a ceiling/floor 1200 in the first configuration. Stated differently, the ceiling/floor 1200 of the slit has a non-linear curve shape, such as an exponentially varying curve shape. An axis 1304 of the graph 1300 illustrates an angle between the driver axis 216 that is normal to the slit axis 218 that runs along the centerline of the slit having the ceiling/floor 1200 in the first configuration. The graph 1300 includes a line 1301 that illustrates a single simulated frequency response. The line 1301 illustrates the frequency response directly in front of the speaker assembly. Therefore, the graph 1300 is a heat map illustrating the change of the sound intensity of the audible output signal in dB (SPL) of the speaker assembly at different angles between the driver axis 216 and a user across different frequencies.

As shown in FIG. 13A, the audible output of the speaker assembly with the slit having a ceiling/floor 1200 in the first configuration advantageously has a better 360° dispersion performance across multiple frequencies than the audio speaker assembly 10 as illustrated by comparing FIGS. 1B and 1D and FIG. 13A. As illustrated in the graph 1300, the sound intensity of the audible output signal across each of the angles have small variations in SPL for each frequency. Stated differently, the color variation in the graph 1300 is more consistent across the various angular positions (e.g., vertically on the graph) for each angle and frequency, showing the audible output is more omni-directional over a wider range of frequencies than the audio speaker assembly 10 graphs illustrated in FIGS. 1B and 1D. Advantageously, a user can be located at any angle and still hear a high quality audible output from either speaker assembly.

The graph 1320 includes an axis 1322 that represents the frequency of the audible output of a speaker assembly with a slit having a ceiling/floor 1200 in the second configuration. Stated differently, the ceiling/floor 1200 of the slit has a uniform non-linear curve shape. An axis 1324 of the graph 1320 illustrates an angle that is measured relative to the centerline of the slit having the ceiling/floor 1200 in the second configuration. The graph 1320 includes a line 1321 that illustrates a single simulated frequency response. The line 1321 illustrates the frequency response directly in front of the speaker assembly. Therefore, the graph 1320 is a heat map illustrating the change of the sound intensity of the audible output in dB of the speaker assembly at different angles between the driver axis 216 and a user across different frequencies.

As shown in FIG. 13B, the audible output of the speaker assembly with the slit having a ceiling/floor in the second configuration advantageously has a better 360° dispersion performance across multiple frequencies than the audio speaker assembly 10 as illustrated by comparing FIGS. 1B and 1D and FIG. 13B. As illustrated in the graph 1320 the sound intensity have small variations in SPL for each frequency. Stated differently, the color variation in the graph 1320 is more consistent across the various angular positions (e.g., vertically on the graph) for each angle and frequency, showing that the audible output is more omni-directional over a wider range of frequencies than the audio speaker assembly 10 graphs illustrated in FIGS. 1B and 1D. Advantageously, a user can be located at any angle and still hear a high quality audible output from either speaker assembly.

The graph 1340 includes an axis 1342 that represents the frequency of the audible output of a speaker assembly with a slit having a ceiling/floor 1200 in the third configuration. Stated differently, the ceiling/floor 1200 of the slit has a chamfer shape. An axis 1344 of the graph 1340 illustrates an angle that is measured relative to the centerline of the slit having the ceiling/floor 1200 in the third configuration. The graph 1340 includes a line 1341 that illustrates a single simulated frequency response taken at or along the zero degree angle, and thus illustrates the frequency response of the speaker assembly at different angles.

As shown in FIG. 13C, the audible output of the speaker assembly with the slit having a ceiling/floor in the third configuration advantageously has a better 360° dispersion performance across multiple frequencies than the audio speaker assembly 10 as illustrated by comparing FIGS. 1B and 1D and FIG. 13C. As illustrated in the graph 1340 the sound intensity of the audible output signal across each of the angles have small variations in SPL for each frequency. Stated differently, the color variation in the graph 1340 is more consistent across the various angular positions (e.g., vertically on the graph) for each angle and frequency, showing the audible output is more omni-directional over a wider range of frequencies than the audio speaker assembly 10 graphs illustrated in FIGS. 1B and 1D. Advantageously, a user can be located at any angle and still hear a high quality audible output from either speaker assembly

The graphs 1300-1340 show that the 360° dispersion performance of a speaker assembly is improved when the ceiling/floor 1200 of a slit has a non-linear curve shape (first configuration) versus a uniform non-linear curve shape (second configuration) or chamfer shape (third configuration). For example, as shown in region 1305 in the graph 1300 and in the graph 1320 there is a smaller change in sound intensity of the audible output for the speaker assembly with the ceiling/floor 1200 of the slit having the first configuration than the second configuration and the third configuration indicating an improvement in directionality (the 360° dispersion performance). Furthermore, as shown in the region 1305 in the graphs 1320 and 1340, the ceiling/floor 1200 of the slit having the second configuration has a better 360° dispersion performance than the ceiling/floor 1200 of the slit having the third configuration.

### Multiple Slit Containing Speaker Assembly Example

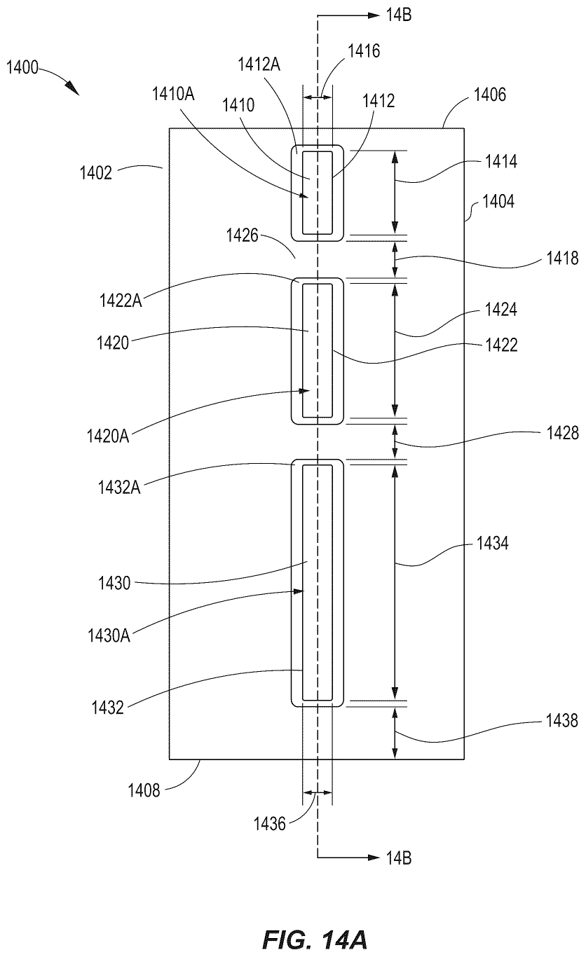

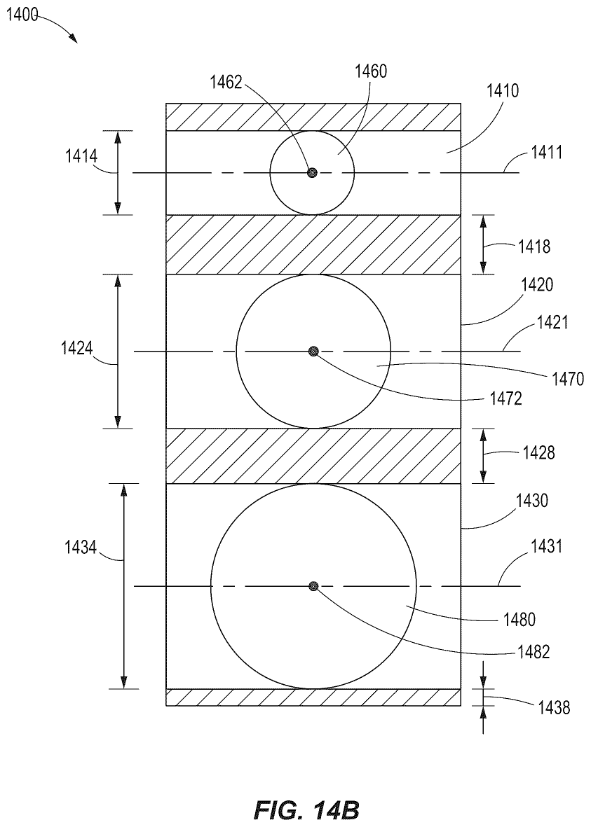

FIG. 14A illustrates a schematic side view of a speaker assembly 1400 that is similarly configured to the speaker assembly 200. The speaker assembly 1400 includes a speaker body 1402 having an outer surface 1404 disposed between a top surface 1406 and bottom surface 1408. The speaker body 1402 includes a first slit 1410, a second slit 1420, and a third slit 1430 protruding through the outer surface 1404. The first slit 1410 includes a first rounded edge 1412 on the perimeter of the first slit 1410 on the outer surface 1404. The first slit 1410 has a first slit height 1414 a first slit width 1416, a slit volume 1410A partially defined by inner surfaces of the first slit 1410 and the front ends of a first pair of drivers 1460, and is a first distance 1418 from the second slit 1420. Similarly, the second slit 1420 includes a second rounded edge 1422 on its perimeter, and has a second slit height 1424, a second slit width 1426, a slit volume 1420A partially defined by inner surfaces of the second slit 1420 and the front ends of a second pair of drivers 1470, and is a second distance 1428 from the third slit 1430. The third slit 1430 includes a third rounded edge 1432, a third slit height 1434, a third slit width 1436, a slit volume 1430A partially defined by inner surfaces of the third slit 1430 and the front ends of a third pair of drivers 1480, and is a third distance 1438 from the bottom surface 1408. Each of the first rounded edge 1412, the second rounded edge 1422, and the third rounded edge 1432 may include a first edge radius 1412A, a second edge radius 1422A, and a third edge radius 1432A, respectively. In some embodiments, the first edge radius 1412A, the second edge radius 1422A, and the third edge radius 1432A may be equal to each other, may differ from each other, or a combination of both such that only two of the edge radiuses are equal. In some embodiments, the first slit 1410, the second slit 1420, and the third slit 1430 include drivers that have an increasing size, respectively, and thus are generally configured to reproduce sound waves within decreasing frequency ranges. In one example, the first slit 1410 is configured to include a high frequency generating driver (e.g., a tweeter that generates frequencies in the 2,000-20,000 Hz range), the second slit 1420 is configured to include a mid-frequency generating driver (e.g., mid-range speaker that generates frequencies in the 250 Hz-2,000 Hz range), and the third slit 1430 is configured to include a low frequency generating driver (e.g., sub-woofer that generates frequencies at <110 Hz). In this decreasing frequency range example, in one embodiment, the first edge radius 1412A will be larger than the second edge radius 1422A, and the second edge radius 1422A will be larger than the third edge radius 1432A. Alternatively or in addition to a rounded or sharp edge, each of the first slit, the second slit, and the third slit may have draft walls at draft angles, e.g., first draft angle, second draft angle, and third draft angle, from the centerlines of their respective slits, e.g., from the first slit 1410, the second slit 1420, and the third slit 1430, similar to the draft walls described in FIGS. 6A-6B. However, in some embodiments, the edge radii can include any transition shape on the edges, such as a circular radius, linear taper, exponential taper, graduating radius, or other useful shape. In other embodiments, each of the edges of the slits (the rounded edges) may be sharp as described in FIGS. 5C and 7A. For example, the first edge radius 1412A, the second edge radius 1422A, and the third edge radius 1432A are all the same size and have a radius that is between zero and 5 mm, such as between 0.1 mm and 3 mm.

FIG. 14B illustrates a schematic, cross-sectional side view of the speaker assembly 1400. A first pair of drivers 1460 is disposed in the first slit 1410, a second pair of drivers 1470 is disposed in the second slit 1420, and a third pair of drivers 1480 is disposed in the third slit 1430. The first pair of drivers 1460 may include drivers with a diameter of between about 15 mm and 40 mm, such as about 25 mm. The second pair of drivers 1470 may comprise drivers with a diameter of between about 70 mm and 170 mm, such as about 102 mm. The third pair of drivers 1480 may comprise drivers with a diameter of between about 190 mm and 600 mm, such as about 305 mm. Further, the first slit height 1414 is configured to substantially match the diameter of the first pair of drivers 1460, the second slit height 1424 is configured to substantially match the diameter of the second pair of drivers 1470, and the third slit height 1434 is configured to substantially match the diameter of the third pair of drivers 1480.

The first pair of drivers 1460 are axially aligned along a first driver axis 1462 that is normal to a first slit axis 1411A that is a centerline of the first slit 1410. Similarly, the second pair of drivers 1470 are axially aligned along a second driver axis 1472 that is normal to a second slit axis 1421A of the second slit 1420 and the third pair of drivers 1480 are axially aligned along a third driver axis 1482 that is normal to a third slit axis 1431A of the third slit 1430. Additionally, in some embodiments, the drivers in each of the pairs of drivers should be of about the same, if not equal, size. For example, the first pair of drivers 1460 may be between about 15 millimeters (mm) to about 170 mm, such as between about 15 mm to about 40 mm, the second pair of drivers may between about 70 mm to about 170 mm, and the third pair of drivers 1480 may be between about 190 mm to about 600 mm. The symmetry in size and coaxial alignment of each of the pairs of drivers minimize undesired destructive interference of the target frequencies during operation of the speaker assembly 1400.

Further, the first edge radius 1412A, the second edge radius 1422A, and the third edge radius 1432A may be sized according to the size of the drivers, which are configured to deliver a frequency range of interest, into the corresponding slit. Each of the first slit 1410, the second slit 1420, or the third slit 1430, or a combination thereof, may include draft walls at draft angles from a center axis of the corresponding slit, as shown in FIGS. 6A-6B. Furthermore, each of the slits and corresponding pairs of drivers may be the same size. Although three slits are shown in the speaker assembly 1400, this is for example purposes only and any suitable quantity of slits may be included in the speaker assembly 1400, such as two slits or four slits, or five slits. In each of the multiple slit containing speaker assembly configurations, at least two of the multiple slits include different sized drivers.

The present disclosure provides a speaker assembly that allows for improved acoustic performance in low-, mid-, and high-frequency ranges, with a simplified design. The speaker assembly designs disclosed herein are configured to provide a desired sound quality, frequency sensitivity, and dispersion of the sound waves across the various frequency ranges at desired SPL levels. In some embodiments, the speaker assembly includes one or more drivers that are positioned on a side of a slit formed through a speaker body. In some embodiments, the speaker assembly includes at least one pair of drivers in a dual-opposed configuration such that the plurality of drivers face each other on opposing sides of a slit through a speaker body. In some embodiments, at least one pair of drivers are coaxially aligned and operate at the same frequency. When operating, at least one pair of drivers push air through the slit at a certain frequency. The slit allows for constructive interference of waves that are in phase, e.g., the same frequency, and destructive interference of waves that are out of phase, e.g., conflicting frequencies, such that the desired frequency is amplified and noise is reduced. The speaker assembly of the present disclosure is characterized by large acoustic volume, reduced complexity in design caused by the potential absence of passive radiators, and improved acoustic performance in a large frequency range, particularly with midrange drivers and tweeters.

### Additional Considerations

When introducing elements of the present disclosure or exemplary aspects or embodiments thereof, the articles “a,” “an,” “the” and “said” are intended to mean that there are one or more of the elements.

The terms “comprising,” “including” and “having” are intended to be inclusive and mean that there may be additional elements other than the listed elements.

The term “coupled” is used herein to refer to the direct or indirect coupling between two objects. For example, if object A physically touches object B and object B touches object C, the objects A and C may still be considered coupled to one another—even if objects A and C do not directly physically touch each other. For instance, a first object may be coupled to a second object even though the first object is never directly in physical contact with the second object.

While the foregoing is directed to embodiments of the present disclosure, other and further embodiments of the disclosure may be devised without departing from the basic scope thereof, and the scope thereof is determined by the claims that follow.

What is claimed is:

1. A speaker assembly, comprising:
a speaker body comprising an outer surface that comprises a first slit exit port and a second slit exit port;
a slit that extends within the speaker body between the first slit exit port and the second slit exit port, and includes a slit volume that is partially defined by inner surfaces of the slit; and
a first driver having a front end that forms part of the inner surface of the slit and defines a first portion of the slit volume.

2. The speaker assembly of claim 1, further comprising a second driver having a front end that forms part of the inner surface of the slit and defines a second portion of the slit volume, wherein the second driver is positioned to face the first driver.

3. The speaker assembly of claim 2, wherein the first driver and the second driver are coaxially aligned along a driver axis normal to a centerline of the slit that is aligned to extend through the first slit exit port and the second slit exit port.

4. The speaker assembly of claim 2, wherein the first slit exit port and the second slit exit port of the slit each include an edge profile comprising draft walls at a draft angle to a centerline of the slit.

5. The speaker assembly of claim 2, wherein the first slit exit port and the second slit exit port of the slit each include an edge profile comprising a slot corner that is curved.

6. The speaker assembly of claim 2, wherein
the first driver and the second driver are coaxially aligned along a driver axis normal to a centerline of the slit, which is aligned to extend through the first slit exit port and the second slit exit port,
the slit includes a slit width and a slit height,
the width is measured in a direction that is parallel to the driver axis, and
the slit width is less than the slit height.

7. The speaker assembly of claim 6, wherein the slit height is from about 10 mm to about 500 mm.

8. The speaker assembly of claim 6, wherein the slit width is from about 10 mm to about 200 mm.

9. The speaker assembly of claim 6, wherein a ratio between the slit width and the slit height is from about 1:9 to about 5:6.

10. The speaker assembly of claim 2, wherein the first driver and the second driver have a diameter from about 4 mm to 200 mm.

11. The speaker assembly of claim 10, wherein the slit has a slit height that is less than or equal to the diameter of the first driver and the second driver.

12. A speaker assembly, comprising:
a speaker body comprising an outer surface that comprises a first slit exit port and a second slit exit port;
a slit that extends within the speaker body between the first slit exit port and the second slit exit port, wherein the first slit exit port and the second slit exit port have a pill shape or a rectangular shape, and the slit includes a slit volume that is partially defined by inner surfaces of the slit; and
a first driver having a front end that forms part of the inner surface of the slit and defines a first portion of the slit volume.

13. The speaker assembly of claim 12, further comprising
a second driver having a front end that forms part of the inner surface of the slit and defines a second portion of the slit volume, wherein the second driver is positioned to face the first driver.

14. The speaker assembly of claim 13, wherein the first driver and the second driver are coaxially aligned along a driver axis normal to a centerline of the slit.

15. The speaker assembly of claim 12, wherein the first slit exit port and the second slit exit port of the slit each include an edge profile comprising a slot corner that is a sharp edge.

16. The speaker assembly of claim 13, wherein the first driver and the second driver are coaxially aligned along a driver axis normal to a centerline of the slit, which is aligned to extend through the first slit exit port and the second slit exit port,
the slit includes a slit width and a slit height,
the width is measured in a direction that is parallel to the driver axis, and
the slit width is less than the slit height.

17. The speaker assembly of claim 16, wherein the slit height is from about 10 mm to about 500 mm.

18. The speaker assembly of claim 16, wherein the slit width is from about 10 mm to about 200 mm.

19. The speaker assembly of claim 16, wherein a ratio between the slit width and the slit height is from about 1:1 to about 1:500.

20. A speaker assembly, comprising:
a speaker body comprising an outer surface that comprises a first slit exit port, a second slit exit port, a third slit exit port and a fourth slit exit port;
a first slit that extends within the speaker body between the first slit exit port and the second slit exit port and the first slit comprises a first slit volume that is partially defined by inner surfaces of the first slit;
a second slit that extends within the speaker body between the third slit exit port and the fourth slit exit port, wherein
the second slit is positioned a first distance from the first slit,
the second slit comprises a second slit volume that is partially defined by inner surfaces of the second slit;
a first pair of drivers disposed within the first slit, each of the first pair of drivers having a front end that forms part of the inner surface of the first slit and defines a portion of the first slit volume; and
a second pair of drivers disposed within the second slit, each of the second pair of drivers having a front end that forms part of the inner surface of the second slit and defines a portion of the second slit volume.

21. The speaker assembly of claim 20, wherein the first pair of drivers are axially aligned along a driver axis normal to a centerline of the first slit, and the second pair of drivers are axially aligned along a driver axis normal to a centerline of the second slit.
